(19) United States
(12) Patent Application Publication
(10) Pub. No.: US 2026/0060246 A1
(43) Pub. Date: Mar. 5, 2026

(54) GERMICIDAL COMPOSITIONS AND WIPES AND METHODS OF MAKING

(71) Applicant: Saferway Research Center, LLC, Westland, MI (US)

(72) Inventor: Aziz Chafic Awad, Westland, MI (US)

(73) Assignee: Saferway Research Center, LLC, Westland, MI (US)

(21) Appl. No.: 19/311,232

(22) Filed: Aug. 27, 2025

Related U.S. Application Data
(60) Provisional application No. 63/687,600, filed on Aug. 27, 2024.

(51) Int. Cl. A01N 25/34; A01N 25/30; A01N 33/12; A01P 1/00

(52) U.S. Cl. CPC A01N 25/34; A01N 25/30; A01N 33/12; A01P 1/00

(57) ABSTRACT

A method of making a clear, homogeneous aqueous antimicrobial composition, the method including: (a) mixing an anionic surfactant with a water-soluble cationic quaternary ammonium (QAC) surfactant in an aqueous medium under conditions effective to form an anionic-rich catanionic mixture that is clear and free of visible precipitate and retains antimicrobial efficacy, wherein: (i) total surfactant concentration is greater than 0.1 wt. %; (ii) weight or molar ratio of anionic to cationic surfactant is greater than 1; and (iii) pH of the medium is greater than or equal to 7 and adjusted with a pH-adjusting agent; and (b) adding an aqueous medium carrier comprising water and, optionally, one or more antimicrobial materials.

### CROSS REFERENCE TO RELATED APPLICATION

This application claims priority to and the benefit of U.S. Provisional Patent Application No. 63/687,600, titled “GERMICIDAL COMPOSITIONS AND WIPES AND METHODS OF MAKING,” and filed on Aug. 27, 2024, the disclosure of which is incorporated herein by reference in its entirety for all purposes.

### FIELD

The present disclosure relates to methods and compositions to overcome the known adverse influence of anionic surfactants upon the water-soluble cationic surfactants (e.g., quaternary ammonium compounds (QACs) and their derivatives), paving the way for simplifying a formulation of homogeneous, clear and stable germicidal aqueous compositions.

### BACKGROUND OF THE PRIOR ART

Cationic surfactants generally do not mix well with anionic surfactants, since the oppositely charged surfactant ions react with one another to produce insoluble catanionic compounds. Compositions comprising mixtures of anionic, cationic and nonionic surfactants are known in the art. This is quite practical since most inexpensive formulas contain anionic and nonionic surfactants and it would be desirable to add to them some cationic substance (e.g., QACs) for germicidal, or softening and antistatic purposes or others. The mixed anionic/cationic systems have shown not only synergistic but also antagonistic effects relative to the properties of the individual surfactant components. For example, softening and antistatic are achieved in such products but unfortunately at the expense of cleaning, or cleaning is achieved but at the expense of germicidal efficacy in the case of QACs.

The germicidal activity of QACs is a function of the N-alkyl chain length and hence lipophilicity (Jain et al., 2014). The initial interaction between QACs and bacterial cells wall results from electrostatic interaction between positively charged QACs and negatively charged bacterial cell membranes, followed by the integration of the hydrophobic tail of the QACs into the bacterial hydrophobic membrane core, where they denature structural proteins and enzymes (Jain et al., 2014).

Sandt et al. (2007) reported that the ammonium groups of the quaternary ammonium compounds cannot be considered as strong binding anchors to the negatively charged species of biofilms. A combination of the ammonium group and a long alkyl chain appears to be required for strong association to biofilms. Their findings suggest that the interactions between the quaternary ammonium groups and the exopolysaccharide matrices of the biofilms are not the prime contribution of the strong QACs binding to the biofilm, and the alkyl chain length plays a role in this association, likely through hydrophobic interactions.

Although QACs are excellent antimicrobials, high concentrations have toxic effect on the skin, eyes and airways (Larsen et al., 2012). Numerous attempts to overcome the aforementioned problems have been tried.

U.S. Pat. No. 8,557,756, to Wu et al., discloses compositions containing a compatible mixture of a cationic surfactant and an anionic surfactant. A composition is provided that includes: (a) a first surfactant of Formula I;

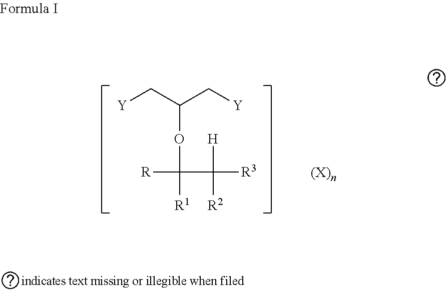

wherein R is linear or branched C₂-C₂₂ alkyl; R¹, R², and R³ are independently H or linear or branched C1-C18 alkyl; Y is S03- or N+R4R5R6; wherein R4, R5, and R6 are independently C1-C4 alkyl, aryl-C1-C4 alkyl, or R4 and R5, together with the nitrogen to which they are attached, form a ring containing 3-9 carbon atoms; X is a monovalent or divalent ion; n is an integer such that the total ionic charge provided by (X)n is 2; and a second surfactant that is oppositely charged to the first surfactant.

U.S. Pat. No. 5,441,541, to Mehreteab et al., discloses the use of water-soluble complexes of anionic and cationic surfactants as superior oily soil removal agents. The surfactants used have hydrophilic groups in addition to their ionic leads. The water-soluble complexes are formed when either or both of the cationic and anionic surfactants contain functional groups (e.g., ethylene oxide groups) with minimum amount of hydrophilicity that remain unaffected (undiminished) during complexation. The degree of solubility depends on the size of the hydrophilic group relative to the total hydrophobic portions of the two components, i.e. on the hydrophilic-lipophilic balance (HLB) of the entire complex.

U.S. Pat. No. 4,298,480, to Wixon, discloses heavy duty dry detergent compositions, for imparting improved softness and detersive effects to fabrics laundered therewith, which compositions include, in addition to conventional builder and principally anionic surfactant components, fatty acid soap and cationic softener of the all-lower-all-higher alkyl quaternary ammonium and/or heterocyclic imide type, e.g., imidazolinium. The soap, in the form of a spaghetti, flake or other shape, is present in the product composition as substantially homogeneously dispersed, discrete particles. The soap spaghetti and cationic amine softener are simply dry blended with the dried detergent in particulate form. In any event, it is advisable to maintain physical separation of the soap and cationic softener and thus inclusion of the softener in the soap spaghetti should be avoided.

U.S. Pat. No. 2,742,434, to Kopp, discloses a cleaner-sanitizer in free-flowing powder form comprising a water-soluble nonionic detergent, a quaternary ammonium detergent germicide, and a brightening agent of the stilbene sulfonate type. Dilute aqueous solutions of this powder clean, disinfect, and brighten soiled clothing such as linen uniforms, and is particularly suitable for use in self-service laundry machines.

U.S. Pat. No. 3,539,520, to Cantor et al., discloses compositions comprising quaternary ammonium germicides and nonionic detergents wherein unique compatibility with respect to performance of the quaternary ammonium germicides is achieved in the presence of amounts of detergent which are at least twice the amount of germicide, by employing a nonionic detergent in which the major portion of the molecule is made up of block polymeric C2 to C4 alkylene oxides, with alkylene oxide blocks containing C3 to C4 alkylene oxides and 0-45% ethylene oxide providing a significant hydrophobic function, and alkylene oxide blocks containing ethylene oxides and 0-45% of C3 to C4 alkylene oxide providing a significant hydrophilic function.

U.S. Pat. No. 3,965,026, to Lancz, discloses a germicidal, all-purpose liquid cleaner contains a quaternary ammonium compound germicide and nitrilo-triacetic acid or its salts. A nonionic surfactant and sodium bicarbonate stabilizer may be included.

U.S. Pat. No. 6,677,294, to Shaw et al., discloses a substantially dry disposable personal care article suitable for cleansing, said article comprising a soft, non-scouring water insoluble substrate, said substrate releasably containing and cleansing compositions comprising one or more surfactants selected from the group consisting of: i) anionic surfactants, ii) amphoteric surfactants, iii) nonionic surfactants, iv) cationic surfactants and v) mixtures thereof, where the dynamic viscosity of the compositions at 25° C. is at least about 100,000 centipoise and where the cleansing composition results in no or minimal eye sting.

U.S. Pat. No. 6,066,674, to Hioki et al., discloses a germicidal-disinfectant detergent composition comprising: (a) a cationic germicide, (b) a metal chelating agent and (c) at least one surfactant selected from anionic surfactants, nonionic surfactants and amphoteric surfactants is described.

U.S. Pat. No. 4,272,395, to Wright, discloses a high foaming germicidal detergent composition suitable for use in dishwashing and in the cleaning and disinfecting of hard surfaces is obtained by combining essentially a quaternary ammonium compound and a co-surfactant selected from the group consisting of short chain anionic surfactants having 3-8 carbon atoms in the hydrophobic group, low alkoxylated non-ionic surfactants having 0-4 ethylene oxide and/or propylene oxide groups in the molecule, and mixtures thereof.

U.S. Pat. No. 4,714,563, to Kajs et al., discloses an antimicrobial toilet bar comprising: (a) a surfactant selected from soaps, anionic synthetic surfactants and mixtures thereof, and (b) an antimicrobial agent selected from chlorhexidine and salts of chlorhexidine which have low solubility in water.

U.S. Pat. No. 3,836,669, to Dadekian, discloses a method of killing bacteria in the presence of hard water and blood serum by contact with from 50 to 3000 ppm of didecyl dimethyl ammonium chloride.

U.S. Published Application No. 2017/0224722 to Macinga et al., discloses a pre-surgical disinfecting composition that includes at least about 50% by weight of a C1-6 alcohol, based upon the total weight of the disinfecting composition, an acid, and a cationic oligomer or polymer.

U.S. Pat. No. 8,119,115 to Synder et al., provides a method of inactivating non-enveloped virus particles that includes the step of contacting the virus with a virucidally-enhanced alcoholic composition that includes an alcohol, and an enhancer selected from the group consisting of cationic oligomers and polymers, proton donors, chaotropic agents, and mixtures thereof.

U.S. Published Application No. 2018/0042226 and U.S. Pat. No. 9,820,482 to Bingham et al., provides compositions and methods for the disinfection of surfaces. The compositions include at least about 40 weight percent of a C1-6 alcohol, and a primary enhancer selected from protein denaturants. The disinfectant composition is characterized by a pH of less than about 3.

U.S. Pat. Nos. 6,482,392; 6,017,561 and 6,270,754, to Zhou et al., relate to a surface cleaning composition comprising approximately 0.05%-15% of an anionic polymer, 0.025%-8% of a quaternary ammonium compound, and a dispersing agent selected from: (i) 0.02%-15% of a nonionic polymer, (ii) 1%-80% of a water miscible solvent, (iii) 0.05%-10% of a surfactant, or mixtures thereof, with the remainder, water. The anionic polymer preferably has an average molecular weight of about 2,000 to 1,000,000, and preferably an acid number larger than about 10. The disadvantages of this include: (1) the anionic surfactant is restricted to anionic polymers or prepolymers, which limit the versatility of the compositions containing such surfactant; and (2) the need for a solubilizing-or-dispersing co-surfactant(s) or organic solvent(s) which consists of 1%-80% volatile organic compounds (VOCs).

U.S. Pat. Nos. 8,728,530; 8,765,114 and 8,883,706, to Scheuing et al. relate to a polymer-micelle complex. The compositions which are free of coacervates and precipitates comprise a water-soluble polymer bearing cationic charges and a negatively charged micelle that comprises a mixed micelle including an anionic surfactant and nonionic surfactant. The nonionic surfactant used included alkyl amine oxide surfactant (e.g., Ammonyx® LO, Ammonyx MO, etc. from Stepan Corp.). Amine oxides in the inventive formulations were explicitly treated as nonionic surfactants according to the applicants. The disadvantages associated with the teaching of this include, but are not limited to: (1) the counterion used for the negatively charged micelle to form what so-called “complex” is just restricted to cationic polymers; and (2) the use of a solubilizing-or-dispersing nonionic co-surfactant(s) such as amine oxide as reported in all the examples, which in turn increase the total solid in the resulting composition and thereby excess in streaking and residues left behind on the treated surface upon drying of the composition.

QACs are frequently used as hard surfaces disinfectants and hand sanitizers in hospitals, institutions and homes. Recently, concern has arisen around the discovery that QACs tend to become attracted to and absorbed into fabrics. Guidelines adopted by the US Centers for Disease Control and Prevention (CDC), “Disinfection and Sterilization in Healthcare Facilities”, indicate that the germicidal effect of QACs is inactivated by cotton fibers, e.g., cotton-based wipes and cloth (Rutala and Webber, 2008). Adsorption of QACs on cotton fibers can be attributed to electrostatic interactions between the positively charged QACs and the negatively charged cotton fibers. This results in a portion of QACs becoming unavailable to adequately kill pathogens. QACs concentrations in commercial products were reduced by up 85.3% after exposure to cotton towels, resulting in failure of the disinfectants exposed to cotton towels in 96% of the Germicidal Spray Tests; whereas when the disinfectants were exposed to microfiber towels, they passed the test (Engelbrecht et al., 2013). They also found no variations in QACs retention by cotton towels at 30- and 180-minutes exposure time of the QACs to the cotton towels. Grieme et al. (2009) reported 78% and 98% QACs retention by cotton wipes in two commercial QACs products after 15 minutes exposure time.

Attempts to alleviate the germicidal inactivation of QACs by cotton-based wipes using biocide release agent have been reported in the prior art.

U.S. Pat. No. 6,841,527, to Mitra et al., discloses compositions comprising a cationic biocide (e.g., QACs, biguanide, etc.), a cationic biocide release agent adapted to promote release of the cationic biocide from absorbent material, detergent builder (e.g., sodium EDTA, etc.), surfactant (e.g., lauryl sulfate, cocamidopropylbetaine, etc.), organic solvent (e.g., ethanol, isopropanol, glycols, etc.) and water. The cleaning compositions can be used as liquid cleaners or in an aerosol form or loaded onto wipes. The problems associated with this approach include: (1) the need for an organic solvent solubilizer which consists of VOCs. Currently, there is a great interest on the state and federal government level to eliminate VOCs in products such as cleaners and disinfecting compositions due to the environmental concerns associated with their use; and (2) the incorporation of biocide release agent to improve the release of the cationic biocide from the absorbent material. The QACs release by the biocide release agent is inconsistent and it has observed to vary from 50% to 100%, thus unreliable.

U.S. Pat. No. 9,006,165 to Mitchell et al., U.S. Pat. Nos. 9,096,821 and 9,234,165 to Hope et al. relate to cleaning compositions including a cationic biocide (e.g., QACs, biguanide, etc.), surfactant mixtures (anionic and nonionic), cationic biocide release agent and organic solvent (e.g., ethanol, isopropanol, glycol ether, etc.). The disadvantages include the incorporation of organic solubilizing or dispersing co-surfactant(s) and organic solvent(s), specifically glycol ether, due to their associated detrimental side effects. A study in Environmental Health Perspectives provides evidence of associations between prenatal exposures to glycol ethers and cognitive impairments in children (Béranger et al., 2017). Moreover, prenatal exposure glycol ethers showed to affect endocrine response patterns estimated by determining blood levels of sex steroid hormones in newborns (Warembourg et al., 2018).

The prior art efforts, however, exhibited various limitations or are overly complex. For instance, these efforts require that one component of the oppositely charged pairs be small in molecular size, or one of the components be weakly charged, or that a co-surfactant/bridging surfactant be used (e.g., addition of nonionic or zwitterionic surfactant as a co-surfactant), or the surfactant must be ethoxylated and/or propoxylated, or limitations on the type of anionic surfactants (e.g., anionic polymers or prepolymer) or cationic surfactants (e.g., cationic polymers or prepolymer), or the necessity of incorporating solubilizing-or-dispersing organic solvents such as glycols, glycol ethers and lower alkanols (e.g., the VOC ethanol) to stabilize the compositions, or according to Salager, 2002, the cationic surfactant must be non-quaternary nitrogenated compounds, and many other limitations. Moreover, the methods to alleviate the germicidal inactivation of QACs by cotton-based wipes using release agents are not consistent nor reliable.

Accordingly, a need remains to overcome known adverse influence of anionic surfactants upon water-soluble QACs in aqueous medium and incorporating solubilizing or dispersing co-surfactants such as nonionic surfactants (e.g., amine oxides and others) or zwitterionic surfactants or organic solvents such as glycols, glycol ethers and lower alkanols and thereby preventing their associated negative side effects; and reducing or preventing the binding of QACs to cotton based wipes or towels without having to incorporate the unreliable QACs release agents.

### SUMMARY

The present disclosure provides for systems and methods to overcome known incompatibility problems of anionic surfactants with water-soluble cationic surfactants, such as QACs which have undesirably precipitated in aqueous compositions and the binding of QACs to cotton based wipes or towels. In an example, the present disclosure provides for a method of making a composition including: (a) mixing an anionic surfactant with a water soluble cationic QACs in an aqueous medium under conditions effective to form an anionic-rich catanionic mixture that is clear and free of visible precipitate and retains antimicrobial efficacy, wherein: (i) the total surfactants concentration used is higher than 0.1 wt. % and/or in another example from about 0.1 wt. % to about 20 wt. %; (ii) the anionic:cationic weight or molar ratio is higher than 1 and/or in another example, from about 1 to 30; and (iii) the pH≥7 and it is provided by basic pH adjusting agent selected from the group consisting of potassium and/or sodium and/or calcium hydroxides, ortho-phosphates, carbonates, and/or bicarbonates; (b) the balance comprising an aqueous carrier selected from water and, optionally, one or more additional antimicrobial such as, but not limited to, metal ion containing compounds, aromatic alcohols, lower alkanols, peroxides, essential oils and their derivatives, salts, salts of organic acids, phenols, antibiotics and water-soluble bisbiguanides to produce antimicrobial compositions to treat a material; (c) incorporating the antimicrobial composition onto cotton or synthetic wipes (substrate) or a blend thereof, in an amount based on the dry weight of the wipe and the desired end use of the wet wipe; and (d) applying, and optionally removing, the aqueous antimicrobial composition of step (b) or (c) to the material to sanitize, disinfect, and/or sterilize the material such as living tissue, inanimate surfaces, soil or atmosphere.

The compositions of the present disclosure constitute a significant advance in the art. In light of the known adverse effects of anionic surfactants upon the water-soluble QACs in aqueous compositions, that compositions of the present disclosure are so stable, homogenous and clear without the need for solubilizing-or-dispersing co-surfactants (e.g., nonionic or zwitterionic surfactants) or organic solvents such as glycols, glycol ethers and lower alkanols and without being limited by the type of anionic or cationic surfactants, whether polymer or prepolymer. Compositions of the present disclosure have strong germicidal efficacy and safer properties than the original quaternary compounds. Most importantly, compositions of this present disclosure reduce or prevent, without the need for biocides release agents that yield inconsistent and unreliable results, the well-known detrimental binding problem of QACs to cotton based wipes or towels, and subsequently reducing or preventing the losses of the germicidal activities of the QACs. In addition of being unreliable, biocides release agents increase the total solid in the resulting composition and thereby cause excess in streaking and residues left behind on the treated surface upon drying of the composition, which is a major undesirable esthetic defect.

It is therefore an object of the present disclosure that the homogeneity, clarity and stability of the compositions are not limited by the type of anionic or cationic surfactants or the need for solubilizing-or-dispersing co-surfactants (e.g., nonionic or zwitterionic surfactants) or organic solvents such as glycols, glycol ethers and lower alkanols. Thus, eliminating the side effects associated with the use of the co-surfactants (e.g., excess in solid materials left behind upon drying of the formulation of surface spray or wipe cleaners that result in undesirable streaking, additional cost, etc.) and the environmental concerns associated with the use of organic solvents, e.g., VOCs and glycol ethers. Moreover, the European Union has restricted the use of several glycol ethers due to concerns about potential reproductive toxicity and other health risks (Seltenrich, 2017). These great advantages and flexibility of the present disclosure make it suitable for several kinds of applications and encourage its regular use in many consumer products such as, for example soaps, hand sanitizers, skin disinfectants, lotions, cosmetics, a delivery system or vehicle for topical active ingredients, sunscreen, agriculture and pesticides applications, shampoos, liquid germicidal spray, microbicidal latex paint and coatings, cleansing agents, laundry detergents, dishwashing liquid and antimicrobial wet wipes, and the like.

It is another object of this present disclosure to provide germicidal compositions that are homogeneous, clear and stable and by that resolving the problems associated with mixing water-soluble QACs and anionic surfactants that have resulted in the formation of precipitate and cloudy unfunctional aqueous compositions that are generally undesirable to the consumer and particularly when being used in clear plastic or glass bottles.

Still another object of the present disclosure is to mitigate or prevent, without the use of QACs release agents that yield inconsistent and unreliable results, the known detrimental binding problem of the positively charged water-soluble QACs to the negatively charged cotton-based wipes or towels, and subsequently reducing or eliminating the losses of their germicidal activities. By contrast to nonwoven polyester wipes or woven polyester washable towels, cotton wipes or towels are natural biodegradable fibers with environmental benefits and offer good absorbency, good wet strength and unique hard surface scrubbing properties. Using synthetic fabrics instead of cotton-based wipes or towels to mitigate or prevent the QACs binding problem have a very detrimental effect on the environment. In fact, several studies have found that synthetic polyester fabrics (e.g., washable towels, clothes and others) contribute to ocean plastic pollution in a subtle but pervasive way by releasing microfibers to the marine environment just by being washed. The released and leached microfibers can be ingested by plankton and other marine organisms, and therefore potentially entering the food web and the water supply (De Falco et al., 2017).

Other technical features may be readily apparent to one skilled in the art from the following figures, descriptions, and claims.

### BRIEF DESCRIPTION OF THE DRAWINGS

FIG. 1 is a side-by-side photographic view comparing between compositions Ex.2, Ex.3, and Ex.4, of which all have the same total surfactants concentration of 1% by weight, same alkaline pH of about 10 but with different anionic:cationic weight ratios. The anionic surfactant is SLS and the water-soluble cationic surfactant is ADBAC. Ex.1 is an aqueous solution of pure SLS and Ex.5 is an aqueous solution of pure ADBAC which served as controls for homogeneity, clarity and stability.

FIG. 2 is a side-by-side photographic view comparing between compositions Ex.7, Ex.8, and Ex.9, which all have the same total surfactants concentration of 1% by weight, same alkaline pH of about 9.6 but with different anionic:cationic weight ratios. The anionic surfactant is SLS and the water-soluble cationic surfactant is ADBAC. Ex.6 is an aqueous solution of pure SLS and Ex.10 is an aqueous solution of pure ADBAC which served as controls for homogeneity, clarity and stability.

FIG. 3 is a side-by-side photographic view comparing between compositions Ex.12, Ex.13 and Ex.14, which all have the same total surfactants concentration of 9% by weight, same alkaline pH of about 12.56 but with different anionic:cationic weight ratios. The anionic surfactant is SLS and the water-soluble cationic surfactant is ADBAC. Ex.11 is an aqueous solution of pure SLS and Ex.15 is an aqueous solution of pure ADBAC which served as controls for homogeneity, clarity and stability.

FIG. 4 is a side-by-side photographic view comparing between compositions Ex.17, Ex.18 and Ex.19, which all have the same total surfactants concentration of 5% by weight, same alkaline pH of about 12.56 but with different anionic:cationic weight ratios. The anionic surfactant is SLS and the water-soluble cationic surfactant is ADBAC. Ex.16 is an aqueous solution of pure SLS and Ex.20 is an aqueous solution of pure ADBAC which served as controls for homogeneity, clarity and stability.

FIG. 5 is a side-by-side photographic view comparing between compositions Ex.22, Ex.23 and Ex.24, which all have the same total surfactants concentration of 1.5% by weight, same alkaline pH of about 12.56 but with different anionic:cationic weight ratios. The anionic surfactant is K Laurate and the water-soluble cationic surfactant is ADBAC. Ex.21 is an aqueous solution of pure K Laurate and Ex.25 is an aqueous solution of pure ADBAC which served as controls for homogeneity, clarity and stability.

FIG. 6 is a side-by-side photographic view comparing between compositions Ex.27, Ex.28 and Ex.29, which all have the same total surfactants concentration of 0.1% by weight, same alkaline pH of about 12.56 but with different anionic:cationic weight ratios. The anionic surfactant is K Laurate and the water-soluble cationic surfactant is ADBAC. Ex.26 is an aqueous solution of pure K Laurate and Ex.30 is an aqueous solution of pure ADBAC which served as controls for homogeneity, clarity and stability.

FIG. 7 is a side-by-side photographic view comparing between compositions Ex.32, Ex.33 and Ex.34, which all have the same total surfactants concentration of 1.5% by weight, same acid pH of about 2.5 but with different anionic:cationic weight ratios. The anionic surfactant is K Laurate and the water-soluble cationic surfactant is ADBAC. Ex.31 is an aqueous solution of pure K Laurate and Ex.35 is an aqueous solution of pure ADBAC which served as controls for homogeneity, clarity and stability.

FIG. 8 is a side-by-side photographic view comparing between compositions Ex.37, Ex.38 and Ex.39, which all have the same total surfactants concentration of 1.5% by weight, same acid pH of about 6 but with different anionic:cationic weight ratios. The anionic surfactant is K Laurate and the water-soluble cationic surfactant is ADBAC. Ex.36 is an aqueous solution of pure K Laurate and Ex.40 is an aqueous solution of pure ADBAC which served as controls for homogeneity, clarity and stability.

FIG. 9 is a side-by-side photographic view comparing between compositions Ex.42, Ex.43 and Ex.44, which all have the same total surfactants concentration of 1.5% by weight, same alkaline pH of about 13 but with different anionic:cationic weight ratios. The anionic surfactant is K Laurate and the water-soluble cationic surfactant is ADBAC. Ex.41 is an aqueous solution of pure K Laurate and Ex.45 is an aqueous solution of pure ADBAC which served as controls for homogeneity, clarity and stability.

FIG. 10 is a side-by-side photographic view comparing between compositions Ex.46, Ex.47 and Ex.48, which all have the same alkaline pH of about 12.56 but with different anionic:cationic weight ratios and total surfactants concentrations. The anionic surfactant is SLS and the water-soluble cationic surfactant is ADBAC.

FIG. 11 is a side-by-side photographic view comparing between compositions Ex.49, Ex.50 and Ex.51, which all have the same alkaline pH of about but with different anionic:cationic weight ratios and total surfactants concentrations. The anionic surfactant is SLS and the water-soluble cationic surfactant is ADBAC.

FIG. 12 is a side-by-side photographic view comparing between compositions Ex.52, Ex.53 and Ex.54, Ex.55, Ex.56 and Ex.57, which all have the same total surfactants concentration of 1% by weight and same alkaline pH of about 10 but with different ethanol content and anionic:cationic weight ratios. The anionic surfactant is SLS and the water-soluble cationic surfactant is ADBAC.

FIG. 13 is a side-by-side photographic view comparing results from Example 6 of antimicrobial activity from PBS, Ex.58, Ex.59, Ex.60, Ex.61, and Ex.62.

FIG. 14 is a photographic view comparing results from Example 9 of antimicrobial activity from PBS, Ex.67, Ex.68, and Ex.69.

FIG. 15 is a photographic view comparing results from Example 10 of antimicrobial activity from PBS, Ex.70, and Ex.71.

FIG. 16 illustrates a process flow chart of a method 1600 in accordance with present disclosure.

### DETAILED DESCRIPTION

The following definition section is provided to more fully describe the present disclosure.

All percentages or parts-per-million (ppm) and ratios used herein, unless otherwise indicated, are by weight and all measurements made are at 20-25° C., unless otherwise designated. This does not mean that heat cannot be used if needed, since the present disclosure works over a broad range of temperatures.

The present disclosure can comprise, consist of, or consist essentially of, the essential as well as optional ingredients and compositions described herein.

All documents referred to herein, including patents, patent applications, and printed publications, are hereby incorporated by reference in their entirety.

As used herein, the “anionic:cationic ratio” can refer to a weight ratio and or molar ratio.

As used herein, the term “aqueous” refers to a composition, solution or mixture which contains at least about 20 weight percent water, or at least about 99 weight percent water and/or at least about 40 weight percent water based on a total weight of the composition, solution or mixture.

As used herein, chaotropic agent refers to a substance that disrupts the structure of, and denatures, macromolecules like proteins and nucleic acids (e.g., DNA and RNA).

As used herein, the term “anionic rich” is meant to mean an ionic excess of surfactant anions over surfactant cations.

As used herein, the term “homogeneous” refers to a composition, solution or mixture whose elements are substantially uniformly dispersed in each other and clear in appearance.

The term “wet wipe” as used herein refers to a wipe or substrate in and on which a composition is distributed by either coating, immersing, dipping or spraying.

The term “evaporation enhancers” as used herein refers to those Generally Recognized As Safe (GRAS) (e.g., food additives) or toxicologically-acceptable ingredients that impart a desirable fast-drying character to the compositions.

The term “biodegradable” as used herein is meant to mean microbial degradation of organic materials.

The term “total surfactants concentration” as used herein refers to the concentration of the anionic surfactants plus the cationic surfactants present in the medium.

The term “natural” as used herein is meant to mean at least 95% of the components of the product are derived from natural sources (e.g., plants and mineral based materials).

Conventional anionic and cationic surfactants are generally not compatible, tending to precipitate when mixed in aqueous solution. Precipitation is undesirable because it renders the surfactants substantially or completely ineffective. Therefore, anionic and cationic surfactants are difficult to mix without the risk of precipitation or instability.

The present disclosure provides a method of making compositions to overcome known adverse influence of anionic surfactants upon water-soluble cationic surfactants (e.g., QACs and their derivatives) in aqueous medium and cotton-based wipes incorporating such compositions. In an example, the method comprises the steps of: (a) mixing an anionic surfactant with water-soluble cationic QACs in an aqueous medium under conditions effective to form an anionic-rich catanionic mixture that is clear and free of visible precipitate and retains antimicrobial efficacy, wherein: (i) the total surfactants concentration used is higher than 0.1 wt. % and/or from about 0.1 wt. % to about 20 wt. %; (ii) the anionic:cationic weight or molar ratio is higher than 1 and/or from about 1 to 30; and (iii) the pH≥7 and it is provided by basic pH adjusting agent selected from the group consisting of potassium and/or sodium and/or calcium hydroxides, ortho-phosphates, carbonates, and/or bicarbonates; (b) a balance comprising an aqueous carrier selected from water and, optionally, one or more additional antimicrobial such as, but not limited to, compounds having metal ions, aromatic alcohols, lower alkanols, peroxides, essential oils and their derivatives, salts, salts of organic acids, phenols, antibiotics and water-soluble bisbiguanides, and combinations thereof, to produce antimicrobial compositions to treat a material; (c) incorporating the antimicrobial composition onto a substrate such as cotton and/or synthetic wipes or a blend thereof, in an amount based on a dry weight of the substrate and a desired end use of the treated substrate; and (d) applying, and optionally removing, the aqueous antimicrobial composition of step (b) or (c) to the material to sanitize, disinfect, and/or sterilize the material such as living tissue, inanimate surfaces, soil or atmosphere.

The compositions of the present disclosure can be used alone as liquid biocides and/or loaded onto wipes. They can be packaged in conventional, ready-to-use dispensing system. Thus, they can be packaged in aerosol form in conventional aerosol containers, fog producing devices, and/or in liquid form in trigger pumps spray bottles and squeeze bottles. They can be impregnated into towelettes and packaged in bulk for individual dispensing. Another preparation of the present disclosure can be saturation of a wipe which is sealed in a foil or other airtight packaging. The packet would be torn open for one-time usage of the wipe delivering the germicidal composition to the material to be treated such as living tissue or inanimate surface.

The compositions of the present disclosure are readily processable and can be prepared by any method known perse in the art; for example, by mixing and/or stirring the correct quantities of individual components for about 0.2 minutes to 30 minutes and more preferably 1 minute at a moderate speed. It is unexpected that the conjoint effect of alkaline pH, total surfactants concentration and anionic:cationic weight and or molar ratio used in the present disclosure has, synergistically, strongly promoted the solubility behavior of the catanionic complexes resulting in homogeneous, clear and stable compositions without having to incorporate solubilizing-or-dispersing co-surfactants (e.g., nonionic or zwitterionic surfactants) or organic solvents such as glycols and lower alkanols and, thereby eliminating the side effects associated with the use of the co-surfactants (e.g., excess in solid materials that result in undesirable streaking, additional cost, safety, etc.) and the environmental concerns associated with the use of organic solvents, e.g., VOCs.

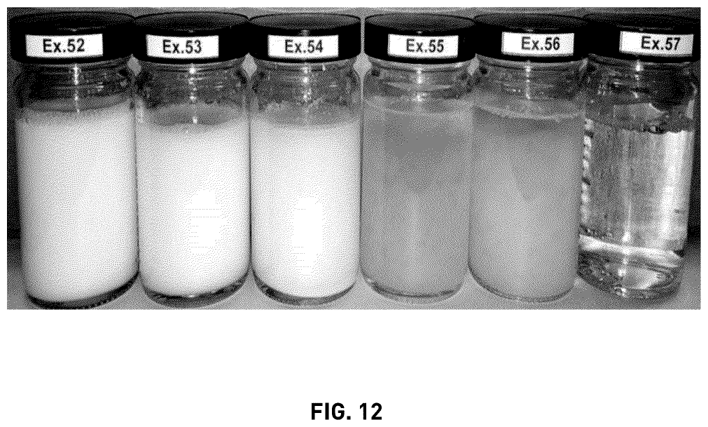

Regulations on the quantity of VOCs that can be used or allowed in cleaners is being promulgated by local, state and federal governments. Moreover, lower alkanols use (e.g., ethanol) is associated with skin irritation or contact dermatitis, and consequent peeling and cracking (Lachenmeier, D. W., 2008). Chapped skin tends to be more susceptible to microbial contamination. Lower alkanols (e.g., ethanol) are very detrimental to several types of finished hard surfaces (e.g., varnished surfaces such as cabinets, furniture, hardwood floor, etc.). In fact, in addition to their VOCs effect, flammability and skin irritation and other disadvantages, lower alkanols based solubilizing solvents are inefficient to deliver the desired and intended results that were obtained by the present disclosure. Table 12 and FIG. 12 show the effect of various levels of ethanol on the homogeneity, clarity and stability of compositions containing both anionic surfactant and water-soluble QACs. The compositions containing ethanol that do not conform to the teaching of the present disclosure were turbid and unstable. As a solubilizing solvent, ethanol failed to deliver the intended results delivered by the present disclosure.

The total surfactants concentration was found to be related to the type of the anionic surfactant. For example, an adequate total surfactants concentration for K. Laurate to get a homogeneous, clear and stable composition may not work for SLS or others, even though the pH and anionic:cationic weight ratio are conforming with the teaching of the present disclosure.

The compositions of the present disclosure reduce or prevent the electrostatic binding of the positively charged QACs to the negatively charged cotton wipes or towels without having to incorporate a biocide release agent, but via electrostatic complexation and neutralization of the water-soluble QACs by the anionic surfactants to form catanionic complexes in an anionic-rich medium prior to loading the compositions onto the wipe. The inclusion of the anionic surfactant, as it is a neutralizer for QACs, would be expected to decrease the antibacterial efficacy of the QACs; however, unexpectedly it resulted in no decrease in QACs activity as compared to the reference control, which is probably due to the alkyl group that remained intact. This has a significant advantage because the alkyl group, hydrophobic tail (e.g., C12, C14 and C16), of the quaternary ammonium compound in the catanionic complexes integrates into the bacterial and fungal hydrophobic membrane core to denature structural proteins, enzymes and by that disrupting the integrity of the lipid membrane, affecting the transport of compounds across the membranes and, finally, leading to cell death.

A biocide release agent is a cationic compound that competes with the cationic biocide for the anionic sites of the cleaning wipe or absorbent materials. The cationic release agent may include a cationic salt (e.g., magnesium sulfate, ammonium chloride, etc.). The type of absorbent materials (e.g., natural or synthetic wipes, cloths, napkins, sponges, etc.) has a substantial effect on the binding and retention of the cationic biocide and, thereby on the effectiveness of the antimicrobial compositions. It has been reported that the release of QACs from cleaning wipes preloaded with antimicrobial compositions containing biocide release agent, varies very widely from 50% to 100%; thus, the effect of biocide release agent is neither consistent nor reliable.

When a cleaning composition is preloaded onto a disposable cleaning wipe, there is in this case some type of control or partial control over the release of the cationic biocide by, for instance, using: (1) different levels of biocides; (2) incorporating biocide release agents; (3) appropriate type of absorbent materials (e.g., non-cotton based) and (4) effective loading ratio. The loading ratio is the weight ratio of composition loaded into the wipe per weight of the wipe (i.e., a 3.5 loading ratio means that 3.5 times the weight of the wipe of formulation was loaded into the wipe). However, when the antimicrobial composition, containing a biocide release agent, is in the form of ready-to-use aerosol or liquid, there is a little or no control over the interaction of the cationic biocide with the absorbent materials. In this case, it is not sufficient nor reliable, at the consumer level, to just count on the presence of the biocide release agent alone in the finished product to control the release or retention of QACs, since none of the other essential monitoring factors to control the release of QACs such as those used for preloaded impregnated disposable wipe described above can be applied. There is no control by the end-users over all these essential QACs release monitoring factors in the case of ready-to-use aerosol or liquid.

The method of allowing the absorbent materials to soak and absorb a high dilution level of QACs to allow the use solution to plateau at the disinfection level is not accurate nor reliable. It is hard to know or control what type of absorbent materials the consumers are using to wipe the material to be cleaned (e.g., natural cotton based or synthetic wipes or towels, cloths, napkins, sponges, etc.), and the repercussion of not using the appropriate compatible absorbent materials could be enormous knowing how important the type of absorbent materials is on the release and retention of QACs. For instance, if the retention of the biocide by the absorbent material used by the end users is high, the available biocide level for sanitizing is low and, thereby the sanitization process fails. However, if the retention of the biocide by the absorbent material used by the end users is low, the available biocide level for sanitizing is high, and although, in this case, the sanitization process succeeds, but high levels of biocide, especially QACs, may become toxic and therefore create a very concerning safety issue (e.g., dermal and eye irritation and others).

Liquid cleaners with high QACs levels are targeted by various local and federal regulations due to the toxicity of the QACs in high concentrations. FDA approved concentrations of QACs that are currently being used in the market for skin care within the range of 0.12-0.14% by weight (e.g., antibacterial hand soap and hand sanitizer, . . . etc.). EPA approved concentrations of QACs that are currently being used in the market for surface care are variable (e.g., Super Sani Cloth® 0.5% QACs by weight, Opti-Cide Max® 0.85% QACs by weight, etc.).

QACs are known for their residual antimicrobial activities, which is one of the great advantages of QACs over other biocides. However, when QACs are applied on hard surfaces in the form of ready-to-use aerosol or liquid and then wiped with a cotton-based cleaning wipe, the QACs bind to the cleaning wipe and there will be no QACs left on the hard surface to impart antimicrobial residual activity, which can be counterproductive and create a sense of false security or safety.

These problems were resolved or alleviated by the teaching of the present disclosure. An advantage of the present disclosure over the prior art is that compositions of the present disclosure are formulated without the incorporation of biocide release agent and, thereby eliminating the false sense of security/safety, and the limitations, inconsistencies and inconveniences associated with it. The compositions of the present disclosure can be applied to and/or used with any absorbent/adsorbent material since the surface charge of the water-soluble QACs in the compositions interacted with the anionic surfactant to form catanionic complexes in an anionic-rich medium; thereby preventing their binding to the anionic sites of the absorbent material and be retained.

In the compositions of the present disclosure, there is no particular limitation for the type of the anionic or cationic surfactants, whether polymer or prepolymer, or the type of wipes, whether cotton based or synthetics.

Useful anionic surfactants component of the compositions herein includes the sulfonates and sulfates such as C6-18 alkyl sulfates and/or sulfonates; C6-15 alkylbenzene sulfonates; C6-18 alkyl ether sulfates of the formulae R—SO3⁻ M, R—Ar—SO3⁻ M and R—O—SO3⁻ M, wherein R is a hydrocarbon group having from about 6 to about 22 carbon atoms which may be linked to the —S03M moiety are alkoxy or oxyalkoxy. In this example, M represents an alkali metal. Useful anionic surfactants can include sodium alkyl sulfate, sodium dodecyl sulfate, sodium dodecylbenzene sulfonate, sodium laureth sulfate sodium lauryl sarcosinate, potassium lauryl sulfate, ammonium lauryl sulfate, ammonium laureth sulfate, ammonium xylene sulfonate, magnesium laureth sulfate, sodium myreth sulfate, sodium nonanoyloxybenzenesulfonate, carboxylates, sulphated esters, sulphated alkanolamides, alkylphenols, and mixtures thereof.

In another embodiment, the anionic surfactant is selected from the group of water-soluble salts of fatty acids (e.g., soaps). Soaps can be made by direct saponification of fats and oils or by the neutralization of free fatty acids. Fatty acid soaps useful herein may include those derived from natural or synthetic fatty acids having from 4 to 30 carbons in the alkyl chain. In another example, alkali metal, e.g. sodium and/or potassium soaps of C8-C24 saturated fatty acids, a particular class being the sodium and/or potassium salts of fatty acid derived from coconut oil and tallow and mixture thereof, e.g. the combination of sodium coconut soap and potassium tallow soap are useful.

Other fatty acid soaps useful herein include those derived from oils of palm groundnut, hardened fish, e.g. cod liver and shark, seal, perilla, linseed, candlenut, hempseed, walnut, poppy seed, sunflower, maize, rapeseed, mustard seed, apricot kernel, almond, soy, castor and olive, etc. In another embodiment, fatty acid soaps can include those derived from the following acids: oleic, stearic, linoleic, palmitoleic, palmitic linolenic, rincinoleic, myristic, lauric, capric, caprylic, caproic, and the like. In yet another example, useful combinations thereof including, without limitation, SLS and K Laurate, 80/20 capric-lauric, 80/20 capric-myristic, 50/50 oleic-capric, 90/10 capric-palmitic and the like. Mixtures of these anionic materials are also within the scope of the present disclosure.

It has been found that from about 0.01% to about 25% by weight, preferably from about 5% to about 10.0% and most preferably 0.1 to about 2% by weight of the anionic surfactant is sufficient. In another example, these weight concentrations of anionic surfactants are required.

Useful water-soluble cationic surfactants component of the compositions can include QACs. The water-soluble QAC's suitable for use in the composition of the present disclosure may include alkyl dimethyl benzyl ammonium chlorides and alkyl dimethyl ethyl benzyl ammonium chlorides in which the alkyl group contains from about 8 to about 18 carbon atoms. Other typical QACs may be used, such as benzethonium chloride, cetrimide, cetylpyridium chloride, alkyl didecyl dimethyl ammonium chloride, dialkyl dimethyl ammonium chloride, ethyl dimethyl stearyl ammonium chloride, benzyl dimethyl stearyl ammonium chloride, benzylbis(hydrogenated tallow alkyl)methyl, bis(hydrogenated tallow alkyl)dimethyl ammonium salts. Methyl poly(oxyethylene)C8-C18 alkyl ammonium chlorides where the poly(oxyethylene)content is n=2-15 and where C8-C18 alkyl is linear and maybe saturated or unsaturated. Mono- and dialkyl quaternary ammonium salts, trimethyl stearyl ammonium chloride, trimethyl cetyl ammonium chloride, dimethyl ethyl lauryl ammonium chloride, dimethyl ammonium chloride and the corresponding bromides and acetates.

Examples of cationic surfactant are selected from alkylamines and their salts, alkyl imidazolines, ethoxylated amines quaternaries, such as alkylbenzyldimethylannnonium salts, alkyl benzene salts, heterocyclic ammonium salts, tetra alkylannnonium salts, and the like, quaternized polysaccharides, alkyl polysaccharides, alkoxylated amines, alkoxylated ether amines, phospholipids and phospholipid derivatives and a mixture thereof.

Useful cationic oligomer or polymers include, but are not limited to, cationic polysaccharides, cationic copolymers of saccharides and synthetic cationic monomers, and synthetic cationic oligomer or polymers. Synthetic cationic oligomers or polymers include cationic polyalkylene imines, cationic ethoxy polyalkylene imines, cationic poly[N-[3-(dialkylammonio)alkyl]N′[3-(alkyleneoxyalkylene dialkylammonio) alkyl]urea dichloride], vinyl caprolactamNP/dialkylamino-alkyl alkylate copolymers, and polyquaternium polymers. Examples of cationic oligomers or polymers include chitosan, copolymers of isophorone diisocyanate and PEG-15 cocamine, vinyl caprolactam/VP/dimethylaminoethyl methacrylate copolymer, polyquaternium-4/hydroxypropyl starch copolymer, butylmethacrylate-(2-dimethylamino-ethyl)methacrylate-methylmethacrylate-copolymer, guar hydroxypropyl trimonium chloride and dilinoleyl amidopropyl dimethylammonium chloride hydroxypropyl copolymer. Examples of preferred quaternary ammonium-containing polymers or oligomers are polyquaternium 1, 2, 3, 4, 5, 6, 7, 8, 9 to polyquaternium-116 or a mixture thereof.

Useful QACs also include organosilane such as 3-(trimethoxysilyl) propyl dimethyl octadecyl ammonium chloride, 3-(trihydroxysilyl)propyl dimethyl octadecyl ammonium chloride and others. The QACs in the present disclosure need not to be a single entity but may be a blend of one or more of QACs.

It has been found that from about 0.010% to about 15.0% by weight, or from about 4.5% to about 10.0% and from 0.01 to about 0.5% by weight of the quaternary germicide is suitable.

The bases suitable for use in the composition of the present disclosure include, but are not limited to, alkali metal hydroxides such as lithium, sodium, potassium, calcium and copper hydroxide; ammonium hydroxide; Na4EDTA; tri- or tetraammonium ethylenediaminetetraacetate (ammonium EDTA); and tri- or tetra potassium ethylenediaminetetraacetate (potassium EDTA). The alkali metal hydroxides can be aqueous or non-aqueous (e.g., ethanolic solutions). Alkali metal or hydrogen carbonates such as sodium carbonate or sodium bicarbonate and alkali metal salts of borates or phosphates can also be used either alone, mixtures thereof, or in conjunction with the bases above. Specific examples of such salts are disodium phosphate, trisodium phosphate, sodium tripolyphosphate, sodium tetraborate, sodium pyrophosphate, potassium pyrophosphate, potassium tripolyphosphate, sodium hexametaphosphate, sodium sesquicarbonate, sodium mono and diorthophosphate, and potassium bicarbonate. The quantity of the alkalinating agents may vary from 0.01% by weight to 12% by weight, and most preferably within the range of 0.05 to 0.3% by weight, e.g. 0.1% by weight, in particular, when the strong alkalinating agents are used (e.g., one or more hydroxides).

The disclosed aqueous compositions can include various optional components, for example one or more thickeners, chelating agents, hydrogen peroxide, emollients, moisturizers, polyols and their derivatives, ethylhexylglycerin (octoxyglycerin), C2-10 alkane diols, corrosion inhibitors, abrasives, anti-acne agents, binders, opacifying agents, foam boosters, hydrotropes, salts, salts of organic acids, humectants, biological additives, enzymes, bulking agents, propellants, salts of alkali metals and alkaline earth metals, copper and zinc compounds, emulsifying waxes, perfumes, essential oils, evaporation enhancers, chaotropic agents, flavoring agents, nerolidol, d-limonene, nonionic surfactants, amphoteric surfactants, amine oxide surfactants, siloxane polymer surfactants, antioxidants, dyes, antibiotics (e.g., doxycycline and ciprofloxacin) and biocides. The amounts of optional components to be employed can readily be determined by one skilled in the art.

Optional biocides useful for the compositions of the present disclosure include metal ion containing compounds, polymeric biocides, heterocyclic compounds, phenols, lower alkanols, organometallics, aldehydes, proteins, peroxygens, polypeptides, halogen releasing compounds and aromatic alcohols with biocidal properties such as benzyl alcohol.

Optional organic acids may include one or more of citric acid, lactic acid, formic acid, acetic acid, sorbic acid, propionic acid, butyric acid, caproic acid, oxalic acid, maleic acid, benzoic acid, salicylic acid, malic acid, valeric acid, carbonic acid, uric acid, and the like, and the salts thereof.

Optional nonionic surfactants may include fatty alcohols such as cetyl alcohol, stearyl alcohol, cetostearyl alcohol, and oleyl alcohol, polyoxamers, ethoxylated fatty alcohols, such as PEG-80 sorbitan laurate, polyoxyethylene glycol alkyl ethers, such as octaethylene glycol monododecyl ether, and pentaethylene glycol monododecyl ether, polyoxypropylene glycol alkyl ethers, glucoside alkyl ethers, polyoxyethylene glycol octylphenol ethers, polyoxyethylene glycol alkylphenol ethers, such as nonoxynol-9, glycerol alkyl esters such as glyceryl laurate, polyoxyethylene glycol sorbitan esters, such as polysorbate, sorbitan alkyl esters, cocamide MEA, cocamide DEA, amine oxides, such as dodecyl dimethylamine oxide, block copolymers of polyethylene glycol and polypropylene glycol, such as poloxamers, polyethoxylated tallow amine, and mixtures thereof.

The alkyl polyglycosides which can be used as nonionic surfactants in the composition are generally represented by the formula II:

R1O(R2O)b(Z)a. wherein R1 is a monovalent organic radical having from about 6 to about 30 carbon atoms; R2 is a divalent alkylene radical having from 2 to 4 carbon atoms; Z is a saccharide residue having 5 or 6 carbon atoms; b is a number having a value from 0 to about 12; a is a number having a value from 1 to about 6.

Examples of preferred polyglucoside include but are not limited to a C8-C16 alkylpolyglucoside such as coco-glucoside, lauryl glucoside, hydroxystearyl glucoside, cetearyl glucoside, caprylyl capryl glucoside, and decyl glucoside, isodecyl glucoside and isotridecyl glucoside and a mixture thereof.

Examples of preferred nonionic surfactants C8-C18 alcohol ethoxylates include, but are not limited to Trideceth 2, 3, 4, 5, 6, 7, 8, 9, 10, 11, 12, 15, 18, 20, 21 and 50, Undeceth 3, 5, 7, 8, 9, 11 and 40, Undecyleneth 6, Ceteth 1, 2, 3, 4, 5, 6, 7, 10, 12, 13, 14, 15, 16, 17, 18, 20, 23, 24, 25, 30, 40, 45 and 150 and Deceth 3, 4, 5, 6, 7, 8, 9 and 10.

Useful nonionic surfactant compositions based on amine oxides including, e.g., (a) alkyl di (lower alkyl) amine oxides in which the alkyl group has about 10-20, and preferably 12-16 carbon atoms, and can be straight or branched chain, saturated or unsaturated, and the lower alkyl groups include between 1 and 7 carbon atoms, e.g., lauryl, dimethyl amine oxide, myristyl dimethyl amine oxide, and those in which the alkyl group is a mixture of different amine oxide, dimethyl cocoamine oxide, dimethyl (hydrogenated tallow) amine oxide, and myristyl/palmityl dimethyl amine oxide, (b) alkyl di (hydroxy lower alkyl) amine oxides in which the alkyl group has about 10-20, and preferably 12-16 carbon atoms, which can be straight or branched chain, saturated or unsaturated, e.g., bis(2-hydroxyethyl) cocoamine oxide, bis(2-hydroxyethyl) tallowamine oxide; and bis(2-hydroxyethyl) stearylamine oxide, (c) alkylamidopropyl di(lower alkyl) amine oxides in which the alkyl group has about 10-20, and preferably 12-16 carbon atoms, and can be straight or branched chain, saturated or unsaturated, e. g., cocoamidopropyl dimethyl amine oxide and tallowamidopropyl dimethyl amine oxide; and (d) alkylmorpholine oxides in which the alkyl group has about 10-20, and preferably 12-16 carbon atoms, and can be straight or branched chain, saturated or unsaturated.

Non-limiting examples of suitable nonionic surfactants are also disclosed in McCutcheon's Detergents and Emulsifiers, 1993 Annals, published by McCutcheon Division, MC Publishing Co., Glen Rock, N.J., pp. 1-246 and 266-273; in the CTFA International Cosmetic Ingredient Dic-tionary, Fourth Ed., Cosmetic, Toiletry and Fragrance Asso-ciation, Washington, D.C. (1991) (hereinafter the CTFA Dictionary) at pages 1-651; and in the CTFA Cosmetic Ingredient Handbook, First Ed., Cosmetic, Toiletry and Fragrance Association, Washington, D.C. (1988) (hereafter the CTFA Handbook), at pages 86-94, each incorporated herein by reference.

Optional GRAS or toxicologically-acceptable evaporation enhancers such as highly volatile monohydric alcohols with low boiling point, ketones and volatile silicone materials or a combination thereof, can be added to enhance the evaporation rate of the compositions of the present disclosure rather than impacting the functional properties of the compositions.

For the purposes of the present disclosure, the term “evaporation enhancers” is understood to include those ingredients that impart a desirable fast-drying character to the compositions in certain applications (e.g., disinfection of hard surfaces, hand sanitizer, cosmetics, paints, moisture sensitive environments, mobile devices such as cell phones, stethoscopes and others, etc.) or a pleasant cooling effect by drawing energy from the body when applied on the skin (e.g., hand soap, body wash, hand sanitizer and cosmetics) that encourages usage by the consumers. It is desirable in this type of applications to maximize the drying rate in order to minimize the waiting time before the sanitized surface may be used. Useful monohydric alcohols are ethanol, n-propanol, isopropanol, or a mixture thereof. Useful volatile silicone materials are cyclomethicone, trimethylsiloxysilicate and low molecular volatile siloxanes. Useful ketones are acetone and others. The proportion of the evaporation enhancer in the compositions of the present disclosure may vary widely depending upon a number of factors, which include among others, the volatility of the evaporation enhancer, the desired drying rate of the germicidal composition, the amount of germicidal composition applied to the material to be treated and the method of application of the germicidal composition, not to mention the prevailing conditions of temperature and relative humidity under which the germicidal composition is to be employed. In general, however, it can be stated that the germicidal compositions must contain at least about 1% by weight of evaporation enhancer to about 80% by weight. Relatively substantial amounts of evaporation enhancer are required to achieve a given drying rate with certain applications and with methods of application which are less efficient in providing a uniform layer of minimal thickness on the surface to be sanitized. Conversely smaller amounts of evaporation enhancer are required with certain applications and when the germicidal composition is applied to the surface to be sanitized in a uniform layer of minimal thickness.

Optional components can include one or more essential oils, whether or not such oils have a desirable scent. In addition to potentially providing a fragrance, essential oils can have antibacterial, antifungal, antiviral, and/or sporicidal effects when included in the disclosed compositions. An essential oil is a concentrated, generally hydrophobic liquid extracted from a plant material that may include some volatile aroma compounds from the plant material. Essential oils contain a variety of constituents, in particular terpenes and terpenoids (e.g., biosynthetic derivatives of isoprene, for example including monoterpenes and sesquiterpenes). Representative terpenes include camphene, caryophyllene, germacrene, limonene, menthone, myrcene, nerol, ocimene, phellandrene, α-pinene, β-pinene, pulegone, terpinene, terpinen-4-ol, thujone, sabinene, isomers thereof, etc. Representative terpenoids include borneol, camphor, citral (or lemonal; geranial and neral isomers) citronellal, eucalyptol (or 1,8-cineole), linalool, isomers thereof, etc. Other terpene/terpenoid-related constituents common in essential oils include carvacrol, cymene (p-), linalyl acetate, menthol, thymol, isomers thereof, etc. Examples of specific suitable plant material extracts include thyme oil, eucalyptus oil, cinnamon oil, orange oil, lemon oil, clove oil, lime oil, rosemary oil, citronella oil, cedar wood oil, camphor oil, calamus oil, geranium oil, lavender, lemongrass oil, peppermint oil, vetiver oil, palmarosa oil, nutmeg oil. When included in the composition, essential oils are preferably incorporated at levels of about 0.01 wt. % to about 10 wt. %, about 0.1 wt. % to about 2 wt. %, about 0.1 wt. % to about 1 wt. %, or about 0.3 wt. % to about 0.7 wt. %, based on the total weight of the composition. As used herein, “essential oil” can generally refer to any of the foregoing specific compounds, classes of compounds, plant extracts, or mixtures/combinations thereof.

Optional chelating agents useful for the compositions of this disclosure include but are not limited to ethylenediamine tetraacetate (EDTA), citric acid esters (e.g., isopropyl citrate, stearyl citrate). Gluconic acid, phosphonic acids, tripolyphosphoric acid, citric acid, maleic acid, polyacrylic acid and salts of organic acids thereof.

Optional salts of alkali metals and alkaline earth metals include, but are not limited to ammonium, calcium, iron, lithium, magnesium, potassium and sodium salts (e.g., ammonium chloride, ammonium iron citrate, calcium chloride, iron perchlorate, lithium perchlorate, lithium acetate, magnesium chloride, sodium chlorate, sodium chloride, sodium chlorite, potassium chloride, etc.)

Optional alkane diols include, but are not limited to ethane-1,2-diol, propane-1,2-diol, butane-1,2-diol, pentane-1,2-diol, hexane-1,2-diol, octane-1,2-diol, nonae-1,2-diol, decane-1,2-diol, or a mixture thereof.

Optional zinc compounds include, but are not limited to aluminum zinc oxide, ammonium silver zinc aluminum silicate, zinc ascorbate, zinc aspartate, zinc borate, zinc borosilicate, zinc carbonate, zinc carbonate hydroxide, zinc chloride, zinc citrate, zinc stearate, zinc sulfate, zinc gluconate.

Optional copper compounds include, but are not limited to copper sulfate, copper citrate, copper acetate, copper chloride, copper carbonate, copper aspartate, copper gluconate, copper powder, copper sulfate, disodium EDTA copper.

Optional chaotropic agents include, but are not limited to urea, thiourea, guanidine chloride, lithium acetate, guanidine thiocyanate, aminoguanidine bicarbonate, guanidine carbonate, guanidine phosphate, and aminoguanidine-HCL, or mixtures thereof.

Optional Polyols include, but are not limited to glycerol, sorbitol, xylitol, maltitol, and a combination thereof.

By way of non-limiting example, the germicidal compositions of this disclosure have potential for use in applications in a wide variety of markets, including in household, personal care, healthcare, interior latex paint and coatings, agriculture, military, textile, food service and processing plants and many others. The compositions disclosed herein are non-toxic, and can be packaged in aerosol form, foam or fog generating devices, or in liquid form in trigger pumps spray bottles and squeeze bottles or impregnated into towelettes made of natural fibers (e.g., cotton-based wipes) or synthetic fibers or a blend thereof (woven or non-woven nature). Such wet wipes can be used for baby wipes, hand wipes, household cleaning wipes, face wipes, cosmetic wipes, household wipes, industrial wipes and the like.

In the following examples, the homogeneity, clarity and turbidity of the compositions were determined by visual examination and measured by Nephelometry using Sper Scientific LUTU-2016 Lutron Turbidity Meter that meets ISO 7027 standards. The turbidity was reported in Nephelometric Turbidity Units (NTU). The testing was performed immediately after the preparation of the compositions and monitored thereafter for the following 12 months.

The solubility of catanionic compounds is demonstrated by stability of aqueous solution of the anionic/cationic surfactant mixtures. Stability is based on homogeneity and clarity of the solutions after 12 months. Homogeneous and clear indicate great stability, cloudy indicates poor stability and turbid indicates very poor stability.

The percentage of QACs retained by cotton-based wipes was determined by quantitatively measuring the concentration of the QACs of the compositions and the reference controls before loading them to the cotton wipes and in the cotton wipes eluates using LC/MS. Samples were analyzed on a Waters G2XS Qt of interfaced with Waters Acquity UPLC system.

The drying time of the compositions having various levels of evaporation enhancers was determined by physical observations (absence of wetness). Glass Petri plates (150×20 mm) were used to represent the surface to be treated. The carriers were pre-cleaned with 70% ethanol, rinsed with distilled water and air dried. The surface of the carrier was wiped up to the edge in a circular fashion without lifting the wipe containing the invented compositions. The carriers were allowed to sit horizontally at ambient temperature (20-25° C.) and humidity (35±5%) until complete dryness is visually observed. The drying time was recorded in seconds.

The disinfecting performance of the subject compositions were evaluated using the using ASTM International Method E2315 at 1 minute contact time.

The following examples are intended to promote a further understanding of the present disclosure. The compositions of the present disclosure are illustrated by examples of specific formulations as described below without, however, being limited thereto. It is to be understood that these examples are provided by way of illustration only and that further useful formulations falling within the scope of the present disclosure may be readily produced by one skilled in the art without deviating from the scope of the present disclosure. (Examples 1-11)

### Example 1

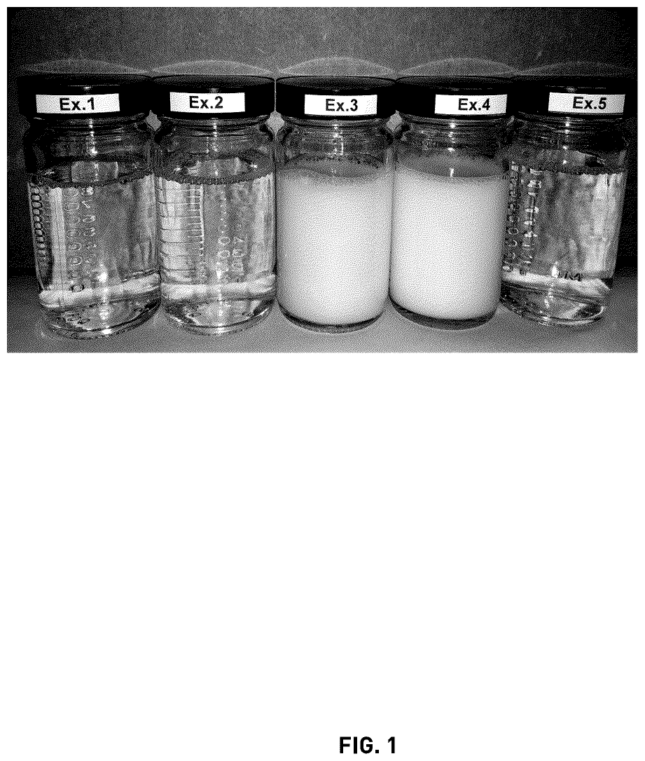

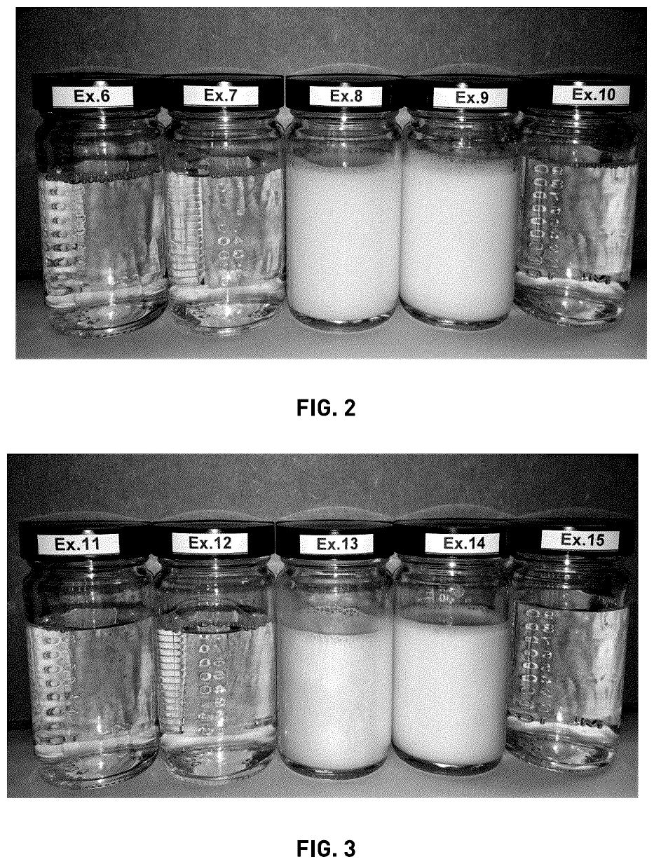

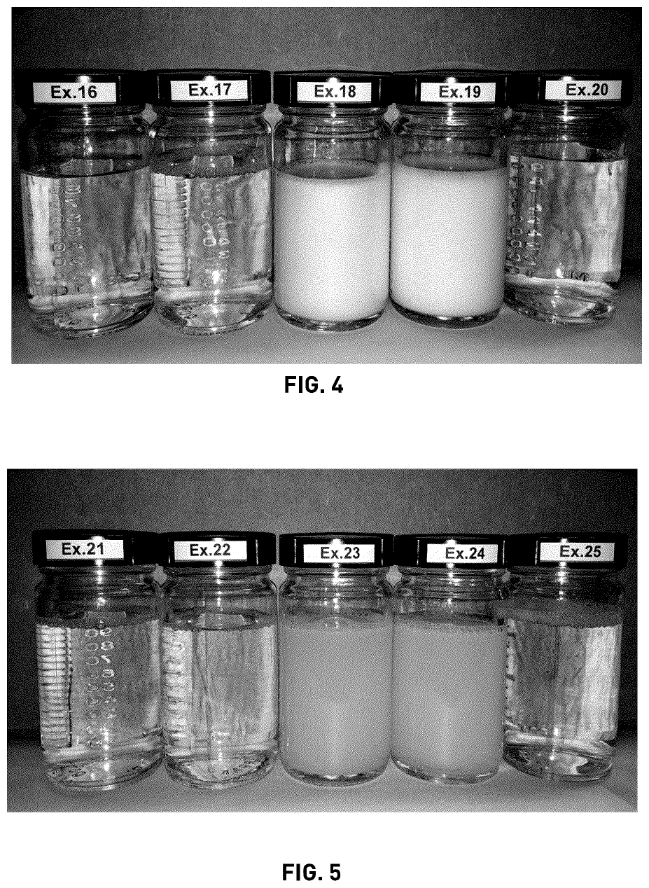

This example shows the importance of an anionic:cationic weight ratio according to the teaching of the present disclosure on the homogeneity, clarity and stability of mixtures of anionic and water-soluble cationic surfactants. It describes compositions shown in Table 1 (Ex.2, Ex.3 and Ex.4), Table 2 (Ex.7, Ex.8 and Ex.9), Table 3 (Ex.12, Ex.13 and Ex.14) and Table 4 (Ex.17, Ex.18 and Ex.19) where the anionic surfactant sodium lauryl sulfate (SLS) was interacted with the cationic surfactant alkyl dimethyl benzyl ammonium chloride (ADBAC) in aqueous alkaline solution to produce catanionic compounds of SLS/ADBAC complexes that lead, depending on the value of anionic:cationic weight ratio, to the formation of clear and stable or turbid compositions. The SLS has a molecular weight of 288 g/mole and an anionic charge of (−1); whereas the ADBAC has an average molecular weight of 351.10 g/mole and a cationic charge of (+1). These experiments show that an anionic:cationic weight ratio ≤1 caused precipitation of catanionic compounds and led to formation of turbid compositions; whereas an anionic:cationic weight ratio >1 gave homogeneous, clear and stable compositions (See, FIGS. 1, 2, 3 and 4). Ex.1, Ex.6, Ex.11, and Ex.16 are aqueous solutions of pure SLS and Ex.5, Ex.10, Ex.15, and Ex.20 are aqueous solutions of pure ADBAC, which served as controls for homogeneity, clarity and stability.

TABLE 1

| | Ex. 1 | Ex. 2 | Ex. 3 | Ex. 4 | Ex. 5 |
|---|---|---|---|---|---|
| Component | (wt. %) | (wt. %) | (wt. %) | (wt. %) | (wt. %) |
| SLS (4.75%, w/w) | 21.05 | 16.84 | 10.52 | 4.21 | 0 |
| ADBAC (50%, w/w) | 0 | 0.4 | 1 | 1.6 | 2 |
| KOH (4.5%, w/w) | 0 | 0.02 | 0 | 0.08. | 0 |
| Distilled Water | 78.95 | 82.74 | 88.48 | 94.11 | 98 |
| SLS:ADBAC weight | — | 4:1 | 1:1 | 1:4 | — |
| ratio | | | | | |
| SLS:ADBAC mole ratio | — | 4.87 | 1.21 | 0.3 | — |
| Total surfactants conc. | 1 | 1 | 1 | 1 | 1 |
| (wt. %) | | | | | |
| pH | 10.03 | 10.3 | 10.3 | 10.3 | 6.26 |
| Appearance | Clear | Clear | Turbid | Turbid | Clear |
| Turbidity (NTU) | 0 | 0 | 587 | 458 | 0 |

The mixture was made up to 100% by weight with distilled water.

TABLE 2

| | Ex. 6 | Ex. 7 | Ex. 8 | Ex. 9 | Ex. 10 |
|---|---|---|---|---|---|
| Component | (wt. %) | (wt. %) | (wt. %) | (wt. %) | (wt. %) |
| SLS (4.75%, w/w) | 21.05 | 15.78 | 10.52 | 5.26 | 0 |
| ADBAC (50%, w/w) | 0 | 0.5 | 1 | 1.5 | 2 |
| KOH (4.5%, w/w) | 0 | 0 | 0 | 0.05 | 0 |
| Distilled Water | 78.95 | 83.72 | 88.48 | 93.19 | 98 |
| SLS:ADBAC weight | — | 3:1 | 1:1 | 1:3 | — |
| ratio | | | | | |
| SLS:ADBAC mole ratio | — | 3.65 | 1.21 | 0.40 | — |
| Total surfactants conc. | 1 | 1 | 1 | 1 | 1 |
| (wt. %) | | | | | |
| pH | 10.03 | 9.6 | 9.6 | 9.6 | 6.26 |
| Appearance | Clear | Clear | Turbid | Turbid | Clear |
| Turbidity (NTU) | 0 | 0 | 706 | 401 | 0 |

The mixture was made up to 100% by weight with distilled water.

TABLE 3

| | Ex. 11 | Ex. 12 | Ex. 13 | Ex. 14 | Ex. 15 |
|---|---|---|---|---|---|
| Component | (wt. %) | (wt. %) | (wt. %) | (wt. %) | (wt. %) |
| SLS (10%, w/w) | 90 | 77.2 | 45 | 12.8 | 0 |
| ADBAC (10%, w/w) | 0 | 12.8 | 45 | 77.2 | 90 |
| KOH (4.5%, w/w) | 0 | 4.50 | 5.29 | 4.09 | 0 |
| Distilled Water | 10 | 5.5 | 4.71 | 5.91 | 10 |
| SLS:ADBAC weight | — | 6:1 | 1:1 | 1:6 | — |
| ratio | | | | | |
| SLS:ADBAC mole ratio | — | 7.35 | 1.21 | 0.2 | — |
| Total surfactants conc. | 9 | 9 | 9 | 9 | 9 |
| (wt. %) | | | | | |
| pH | 10.35 | 12.56 | 12.56 | 12.56 | 6.46 |
| Appearance | Clear | Clear | Turbid | Turbid | Clear |
| Turbidity (NTU) | 0 | 0.23 | 128 | 187 | 0 |

The mixture was made up to 100% by weight with distilled water.

TABLE 4

| | Ex. 16 | Ex. 17 | Ex. 18 | Ex. 19 | Ex. 20 |
|---|---|---|---|---|---|
| Component | (wt. %) | (wt. %) | (wt. %) | (wt. %) | (wt. %) |
| SLS (10%, w/w) | 50 | 42.9 | 25 | 7.1 | 0 |
| ADBAC (10%, w/w) | 0 | 7.1 | 25 | 42.9 | 50 |
| KOH (4.5%, w/w) | 0 | 3.85 | 4.49 | 3.48 | 0 |
| Distilled Water | 50 | 46.15 | 45.51 | 46.52 | 50 |
| SLS:ADBAC weight | — | 6:1 | 1:1 | 1:6 | — |
| ratio | | | | | |
| SLS:ADBAC mole ratio | — | 7.37 | 1.21 | 0.2 | — |
| Total surfactants conc. | 5 | 5 | 5 | 5 | 5 |
| (wt. %) | | | | | |
| pH | 10.25 | 12.56 | 12.56 | 12.56 | 6.32 |
| Appearance | Clear | Clear | Turbid | Turbid | Clear |
| Turbidity (NTU) | 0 | 0 | 206 | 238 | 0 |

The mixture was made up to 100% by weight with distilled water.

### Example 2

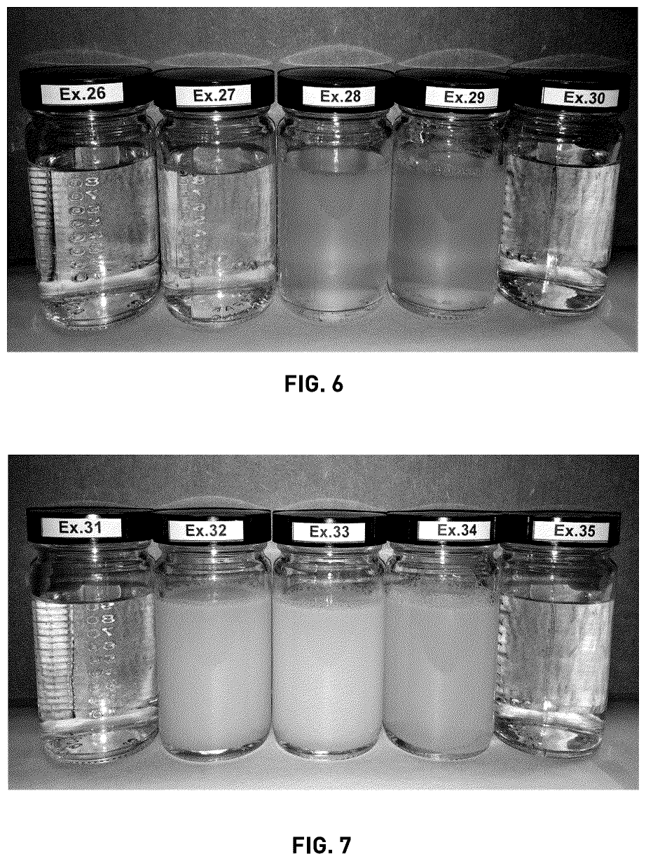

This example shows the effect of the anionic:cationic weight ratio according to the present disclosure on the homogeneity, clarity and stability of mixtures of anionic and water-soluble cationic surfactants. It describes compositions shown in Table 5 (Ex.22, Ex.23 and Ex.24) with a total surfactant concentration of 1.5% and Table 6 (Ex.27, Ex.28 and Ex.29) with a total surfactant concentration of 0.1%. The anionic surfactant is a fatty acid soap, potassium laurate (K Laurate). K Laurate was interacted with the cationic surfactant ADBAC in aqueous alkaline solution to produce catanionic compounds of Laurate/ADBAC complexes that lead, depending on the value of anionic:cationic weight ratio, to the formation of clear and stable or turbid compositions. The K Laurate has a molecular weight of 238.42 g/mole and an anionic charge of (−1); whereas the ADBAC has an average molecular weight of 351.10 g/mole and a cationic charge of (+1). These experiments show that an anionic:cationic weight ratio ≤1 caused precipitation of catanionic compounds and led to formation of turbid or cloudy compositions; whereas an anionic:cationic weight ratio >1 gave homogeneous, clear and stable compositions (See e.g., FIGS. 5 and 6). Ex.21 and Ex.26 are aqueous solution of pure K Laurate and Ex.26 and Ex.30 are aqueous solution of pure ADBAC which served as controls for homogeneity, clarity and stability.

TABLE 5

| | Ex. 21 | Ex. 22 | Ex. 23 | Ex. 24 | Ex. 25 |
|---|---|---|---|---|---|
| Component | (wt. %) | (wt. %) | (wt. %) | (wt. %) | (wt. %) |
| K Laurate (4.75%, w/w) | 31.57 | 21.15 | 15.78 | 10.42 | 0 |
| ADBAC (4.75%, w/w) | 0 | 10.42 | 15.78 | 21.15 | 31.57 |
| KOH (4.5%, w/w) | 0 | 2.76 | 3.53 | 2.45 | 0 |
| Distilled Water | 68.43 | 65.67 | 64.91 | 65.98 | 68.43 |
| K Laurate:ADBAC | — | 2:1 | 1:1 | 1:2 | — |
| weight ratio | | | | | |
| K Laurate:ADBAC mole | — | 2.99 | 1.47 | 0.72 | — |
| ratio | | | | | |
| Total surfactants conc. | 1.5 | 1.5 | 1.5 | 1.5 | 1.5 |
| (wt. %) | | | | | |
| pH | 12.12 | 12.56 | 12.56 | 12.56 | 6.29 |
| Appearance | Clear | Clear | Turbid | Turbid | Clear |
| Turbidity (NTU) | 0 | 0.32 | 733 | 423 | 0 |

The mixture was made up to 100% by weight with distilled water.

TABLE 6

| | Ex. 26 | Ex. 27 | Ex. 28 | Ex. 29 | Ex. 30 |
|---|---|---|---|---|---|
| Component | (wt. %) | (wt. %) | (wt. %) | (wt. %) | (wt. %) |
| K Laurate (4.75%, w/w) | 2.1 | 1.4 | 1 | 0.7 | 0 |
| ADBAC (4.75%, w/w) | 0 | 0.7 | 1 | 1.4 | 2.1 |
| KOH (4.5%, w/w) | 0 | 1.47 | 1.38 | 1.43 | 0 |
| Distilled Water | 99.79 | 96.43 | 96.62 | 96.47 | 99.79 |
| K Laurate:ADBAC | — | 2:1 | 1:1 | 1:2 | — |
| weight ratio | | | | | |
| K Laurate:ADBAC mole | — | 2.94 | 1.47 | 0.73 | — |
| ratio | | | | | |
| Total surfactants conc. | 0.1 | 0.1 | 0.1 | 0.1 | 0.1 |
| (wt. %) | | | | | |
| pH | 10.23 | 12.56 | 12.56 | 12.56 | 6.15 |
| Appearance | Clear | Clear | Cloudy | Cloudy | Clear |
| Turbidity (NTU) | 0 | 0.35 | 37.72 | 42.50 | 0 |

The mixture was made up to 100% by weight with distilled water.

### Example 3

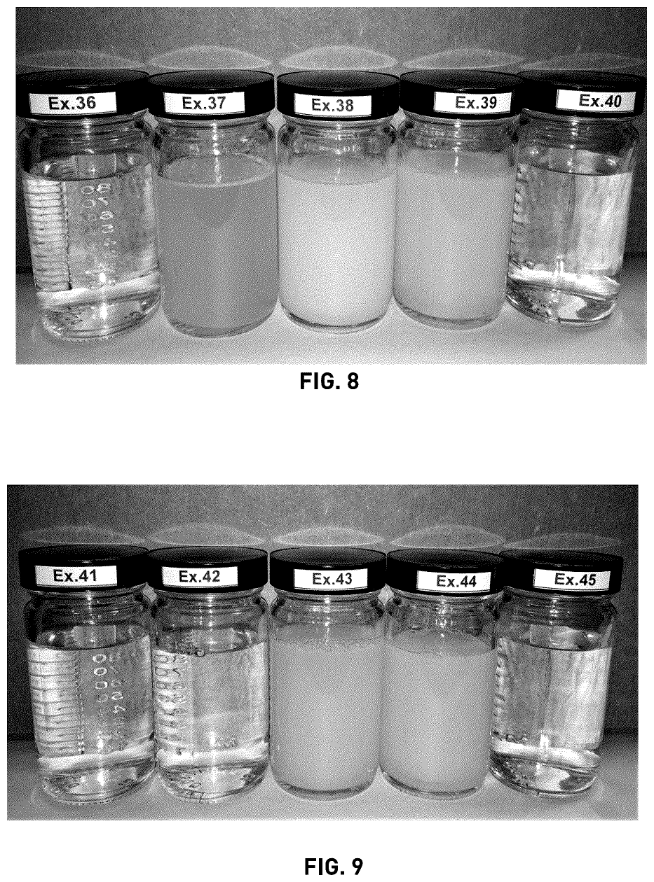

This example illustrates a conjoint effect of pH and anionic:cationic weight ratio on the homogeneity, clarity and stability of mixtures of anionic and water-soluble cationic surfactants. It describes compositions shown in Table 7 (Ex.32, Ex.33 and Ex.34), Table 8 (Ex.37, Ex.38 and Ex.39) and Table 9 (Ex.42, Ex. 43 and Ex.44) where the anionic surfactant, the fatty acid soap K Laurate, was interacted with the cationic surfactant ADBAC in aqueous alkaline solution to produce catanionic compounds of Laurate/ADBAC complexes that lead, depending on the final pH of the medium and the anionic:cationic weight ratio, to the formation of homogeneous, clear and stable or turbid compositions (FIGS. 7, 8 and 9). Ex.31, Ex.36 and Ex.41 are aqueous solutions of pure K Laurate and Ex.35, Ex.40 and Ex.45 are aqueous solution of pure ADBAC which served as controls for homogeneity, clarity and stability. Table 7, 8 and 9 show the importance of the conjoint effect of alkaline pH and anionic:cationic weight ratio >1 on the homogeneity, stability and clarity of the compositions. Ex.42 is homogeneous, stable and clear. It has a total surfactants concentration of 1.5%, an alkaline pH of 13 and an anionic:cationic weight ratio >1 (2:1). Ex.42 is homogeneous, stable and clear because it conforms to the teaching of the present disclosure. Whereas Ex.43 and Ex.44 are turbid even though they have the same total surfactants concentration of 1.5% and the same alkaline pH of 13 as Ex.42. Ex.43 and Ex.44 are turbid because their anionic:cationic weight ratio is 51, which is not conforming. Moreover, Ex.32 with a final pH adjusted to the acid side (pH=2.5) after the formation of Laurate/ADBAC complexes in an alkaline medium and Ex.37 with a final pH adjusted to the acid side (pH=6) after the formation of Laurate/ADBAC complexes in an alkaline medium are both turbid even though they have the same total surfactants concentration of 1.5% and anionic:cationic weight ratio >1 (2:1) as Ex.42. Ex.32 and Ex.37 are both turbid because their final pH is not on the alkaline side and, therefore is not conforming to the teaching of the present disclosure. Ex.33, Ex.34, Ex.38 and Ex.39 are all turbid because their final pH was adjusted to the acid side after the formation of Laurate/ADBAC complexes in an alkaline medium, and their anionic:cationic weight ratios 51, therefore they are not conforming to the teaching of the present disclosure.

The homogeneity, clarity and stability of the compositions of the present disclosure are a function of the conjoint effect of alkaline pH and anionic:cationic weight ratio >1. Ex.32 and Ex.37 show that by adjusting the final pH to the acid side after the formation of Laurate/ADBAC complexes in an alkaline medium, the single effect of anionic:cationic weight ratio >1, alone, at a pH<7 is not capable of producing homogeneous, clear and stable composition as observed in Ex.42. Moreover, the single effect of alkaline pH after the formation of Laurate/ADBAC complexes in an alkaline medium, alone, in Ex.43 and Ex.44 without an anionic:cationic weight ratio >1 is not capable of producing homogeneous, clear and stable compositions. However, when a final alkaline pH is coupled with an anionic:cationic weight ratio >1 in accordance with the teaching of the present disclosure as described in Ex.42, the catanionic complexes were dissolved and the composition was homogeneous, clear and stable.

TABLE 7

| | Ex. 31 | Ex. 32 | Ex. 33 | Ex. 34 | Ex. 35 |
|---|---|---|---|---|---|
| Component | (wt. %) | (wt. %) | (wt. %) | (wt. %) | (wt. %) |
| K Laurate (4.75%, w/w) | 21.05 | 21.15 | 15.78 | 10.42 | 0 |
| ADBAC (4.75%, w/w) | 0 | 10.42 | 15.78 | 21.15 | 21.05 |
| KOH (4.5%, w/w) | 0 | 0 | 0 | 0 | 0 |
| Lactic acid (88%, w/w) | 0 | 2.96 | 1.65 | 1.10 | 0 |
| Distilled Water | 78.95 | 65.47 | 66.79 | 67.33 | 78.95 |
| K Laurate:ADBAC | — | 2:1 | 1:1 | 1:2 | — |
| weight ratio | | | | | |
| K Laurate:ADBAC mole | — | 2.99 | 1.47 | 0.72 | — |
| ratio | | | | | |
| Total surfactants conc. | 1.5 | 1.5 | 1.5 | 1.5 | 1.5 |
| (wt. %) | | | | | |
| pH | 11.88 | 2.5 | 2.5 | 2.5 | 6.30 |
| Appearance | Clear | Turbid | Turbid | Cloudy | Clear |
| Turbidity (NTU) | 0 | 1204 | 732 | 426 | 0 |

The mixture was made up to 100% by weight with distilled water.

TABLE 8

| | Ex. 36 | Ex. 37 | Ex. 38 | Ex. 39 | Ex. 40 |
|---|---|---|---|---|---|
| Component | (wt. %) | (wt. %) | (wt. %) | (wt. %) | (wt. %) |
| K Laurate (4.75%, w/w) | 21.05 | 21.15 | 15.78 | 10.42 | 0 |
| ADBAC (4.75%, w/w) | 0 | 10.42 | 15.78 | 21.15 | 21.05 |
| KOH (4.5%, w/w) | 0 | 0 | 0 | 0 | 0 |
| Lactic acid (88%, w/w) | 0 | 0.33 | 0.19 | 0.07 | 0 |
| Distilled Water | 78.95 | 68.1 | 68.25 | 68.36 | 78.95 |
| K Laurate:ADBAC | — | 2:1 | 1:1 | 1:2 | — |
| weight ratio | | | | | |
| K Laurate:ADBAC mole | — | 2.99 | 1.47 | 0.72 | — |
| ratio | | | | | |
| Total surfactants conc. | 1.5 | 1.5 | 1.5 | 1.5 | 1.5 |
| (wt. %) | | | | | |
| pH | 11.88 | 6 | 6 | 6 | 6.30 |
| Appearance | Clear | Cloudy | Turbid | Cloudy | Clear |
| Turbidity (NTU) | 0 | 542 | 875 | 436 | 0 |

The mixture was made up to 100% by weight with distilled water.

TABLE 9

| | Ex. 41 | Ex. 42 | Ex. 43 | Ex. 44 | Ex. 45 |
|---|---|---|---|---|---|
| Component | (wt. %) | (wt. %) | (wt. %) | (wt. %) | (wt. %) |
| K Laurate (4.75%, w/w) | 21.05 | 21.15 | 15.78 | 10.42 | 0 |
| ADBAC (4.75%, w/w) | 0 | 10.42 | 15.78 | 21.15 | 21.05 |
| KOH (4.5%, w/w) | 0 | 4.84 | 5.23 | 4.61 | 0 |
| Distilled Water | 78.95 | 63.59 | 63.21 | 63.82 | 78.95 |
| K Laurate:ADBAC | — | 2:1 | 1:1 | 1:2 | — |
| weight ratio | | | | | |
| K Laurate:ADBAC mole | — | 2.99 | 1.47 | 0.72 | — |
| ratio | | | | | |
| Total surfactants conc. | 1.5 | 1.5 | 1.5 | 1.5 | 1.5 |
| (wt. %) | | | | | |
| pH | 11.88 | 13 | 13 | 13 | 6.3 |
| Appearance | Clear | Clear | Cloudy | Cloudy | Clear |
| Turbidity (NTU) | 0 | 1.16 | 652 | 465 | 0 |

The mixture was made up to 100% by weight with distilled water.

### Example 4

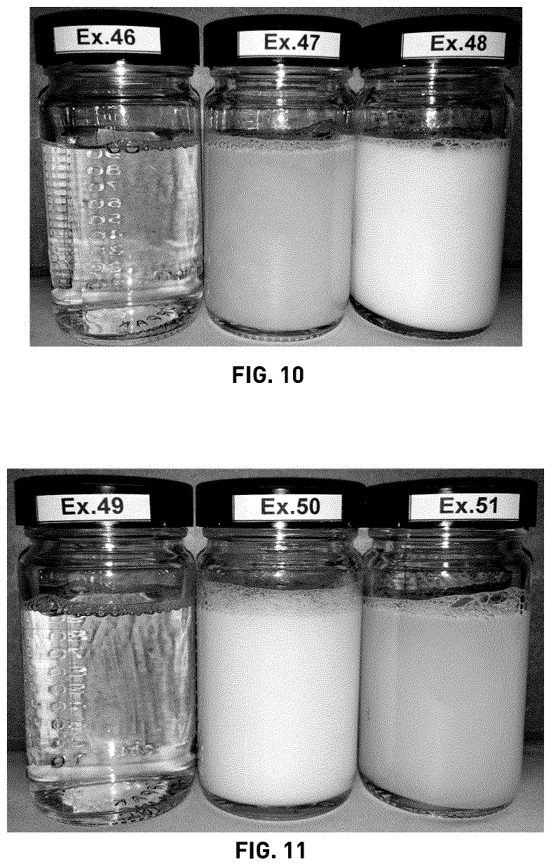

This example demonstrates the importance of the conjoint effect of total surfactants concentration and anionic:cationic weight ratio on the homogeneity, clarity and stability of mixtures of anionic and water-soluble cationic surfactants. It describes compositions shown in Table 10 (Ex.46, Ex.47 and Ex.48) and Table 11 (Ex.49, Ex.50 and Ex.51) where the anionic surfactant SLS was interacted with the cationic surfactant ADBAC in aqueous alkaline solution to produce catanionic compounds of SLS/ADBAC complexes that lead, depending on the anionic:cationic weight ratio and total surfactants concentration, to the formation of homogeneous, clear and stable or turbid compositions (See e.g., FIGS. 10 and 11). Table 10 and 11 show the importance of the conjoint effect of adequate total surfactants concentrations and anionic:cationic weight ratio >1 on the homogeneity, clarity and stability of the compositions. Ex.46 and Ex.47 both have an anionic:cationic weight ratio >1 and the same alkaline pH of 12.56; however, they have different total surfactants concentrations. Ex.46 with an adequate total surfactants concentration of 5% was homogeneous, clear and stable; whereas Ex.47 with an inadequate total surfactant concentration of 0.1% was turbid. Ex.48 has the same adequate total surfactants concentration of 5% and alkaline pH of 12.56 as Ex.46, but the anionic:cationic weight ratio is <1, it was turbid (FIG. 10). Ex.48 is turbid because its anionic:cationic weight ratio is <1, which is not conforming to the teaching of the present disclosure. Moreover, Ex.49 and Ex.51 both have an anionic:cationic weight ratio >1 and the same alkaline pH of 10, but they have different total surfactants concentrations. Ex.49 with an adequate total surfactant concentration of 0.5% was homogeneous, clear and stable; whereas Ex.51 with an inadequate total surfactant concentration of 0.1% was turbid. Ex.50 has the same total surfactants concentration of 0.5% and alkaline pH of 10 as Ex.49, but the anionic:cationic weight ratio is <1, it was turbid (FIG. 11). Ex.50 is turbid because its anionic:cationic weight ratio is <1, which is not conforming to the teaching of the present disclosure.

The comparison of the test results in Table 10 and 11 clearly show that the homogeneity, clarity and stability of the compositions consistent with the teaching of the present disclosure is function of the conjoint effect of adequate total surfactants concentration and anionic:cationic weight ratio >1. An anionic:cationic weight ratio >1 is essential but not sufficient by itself to get a homogeneous, clear and stable composition, the total surfactants concentration has a role too. Ex.46, Ex.47, Ex.49 and Ex.51 show that without having an adequate total surfactants concentration, the single effect of anionic:cationic weight ratio >1, alone, is not capable of producing homogeneous, clear and stable composition. Moreover, the single effect of having an adequate total surfactants concentration, alone, in Ex.48 and Ex.50 without an anionic:cationic weight ratio >1 is not capable of producing homogeneous, clear and stable compositions. However, when an adequate total surfactants concentration is coupled with an anionic:cationic weight ratio >1 in accordance with the teaching of the present disclosure as described in Ex.46 and Ex.49, the catanionic complexes were dissolved and the compositions were homogeneous, clear and stable.

TABLE 10

| | Ex. 46 | Ex. 47 | Ex. 48 |
|---|---|---|---|
| Component | (wt. %) | (wt. %) | (wt. %) |
| SLS (10%, w/w) | 42.9 | 0.85 | 7.1 |
| ADBAC (10%, w/w) | 7.1 | 0.15 | 42.9 |
| KOH (4.5%, w/w) | 3.55 | 0.458 | 3.37 |
| Distilled Water | 46.45 | 98.54 | 46.63 |
| SLS:ADBAC weight ratio | 6:1 | 6:1 | 1:6 |
| SLS:ADBAC mole ratio | 7.37 | 6.9 | 0.2 |
| Total surfactants conc. (wt. %) | 5 | 0.1 | 5 |
| pH | 12.56 | 12.56 | 12.56 |
| Appearance | Clear | Turbid | Turbid |
| Turbidity (NTU) | 0 | 605 | 243 |

The mixture was made up to 100% by weight with distilled water.

TABLE 11

| | Ex. 49 | Ex. 50 | Ex. 51 |
|---|---|---|---|
| Component | (wt. %) | (wt. %) | (wt. %) |
| SLS (10%, w/w) | 4 | 1 | 0.8 |
| ADBAC (10%, w/w) | 1 | 4 | 0.2 |
| KOH (4.5%, w/w) | 0 | 0 | 0.01 |
| Distilled Water | 95 | 95 | 98.99 |
| SLS:ADBAC weight ratio | 4:1 | 1:4 | 4:1 |
| SLS:ADBAC mole ratio | 4.88 | 0.3 | 4.88 |
| Total surfactants conc. (wt. %) | 0.5 | 0.5 | 0.1 |
| pH | 10.03 | 10.01 | 10.09 |
| Appearance | Clear | Turbid | Turbid |
| Turbidity (NTU) | 0 | 462 | 888 |

The mixture was made up to 100% by weight with distilled water.

### Example 5

This example shows the effect of lower alkanols solvents such as ethanol on the homogeneity, clarity and stability of mixtures of anionic and water-soluble cationic surfactants. It describes compositions shown in Table 12 (Ex.52, Ex.53, Ex.54, Ex.55, Ex.56 and Ex.57) where the anionic surfactant SLS was interacted with the cationic surfactant ADBAC in aqueous alkaline solution to produce catanionic compounds of SLS/ADBAC complexes that lead to the formation of homogeneous, clear and stable or turbid compositions (FIG. 12). Ex.52, with a total surfactant concentration of 1% and alkaline pH of 10, is turbid because the anionic:cationic weight ratio weight ratio is <1, which is not conforming to the teaching of the present disclosure. Ex.53, Ex.54 and Ex.55 and Ex.56 have a total surfactant concentration of 1%, an alkaline pH of 10 and anionic:cationic weight ratio <1, but with the addition of various levels of ethanol ranging from 3% to 50% by weight. Ex.53, Ex.54 and Ex.55 and Ex.56 are turbid because their anionic:cationic weight ratio is <1, which is not conforming to the teaching of the present disclosure and the addition of ethanol did not resolve the turbidity and instability problem. Ethanol was unable to dissolve the insoluble catanionic compounds, therefore, the compositions formulated with ethanol were turbid and unstable. Whereas Ex.57 which was formulated in accordance with the teaching of the present disclosure is homogeneous, clear and stable. It has the same total surfactants concentration of 1% and alkaline pH of 10 as in Ex.52, Ex.53, Ex.54 and Ex.55 and Ex.56, but with an anionic:cationic weight ratio is >1 and no ethanol.

Compositions formulated as described in Ex.53, Ex.54, Ex.55 and Ex.56 that do not conform to the teaching of the present disclosure with the addition of ethanol are turbid and unstable and, clearly and unequivocally demonstrate that lower alkanols solvent such as ethanol is inefficient to deliver the intended results delivered by the present disclosure.

TABLE 12

| | Ex. 52 | Ex. 53 | Ex. 54 | Ex. 55 | Ex. 56 | Ex. 57 |
|---|---|---|---|---|---|---|
| Component | (wt. %) | (wt. %) | (wt. %) | (wt. %) | (wt. %) | (wt. %) |
| SLS (10%, w/w) | 2 | 2 | 2 | 2 | 5 | 8 |
| ADBAC (10%, w/w) | 8 | 8 | 8 | 8 | 5 | 2 |
| KOH (4.5%, w/w) | 0.07 | 0.07 | 0.05 | 0.06 | 0.01 | 0 |
| Distilled Water | 89.93 | 86.93 | 69.95 | 39.94 | 39.99 | 90 |
| Ethanol 200 Proof (%, w/w) | 0 | 3 | 20 | 50 | 50 | 0 |
| SLS:ADBAC wt. ratio | 1:4 | 1:4 | 1:4 | 1:4 | 1:1 | 4:1 |
| SLS:ADBAC mole ratio | 0.3 | 0.3 | 0.3 | 0.3 | 1.22 | 4.88 |
| Total surfactants conc. (wt. %) | 1 | 1 | 1 | 1 | 1 | 1 |
| pH | 10.04 | 10.06 | 10.1 | 10.07 | 10.1 | 10.08 |
| Appearance | Turbid | Turbid | Turbid | Turbid | Turbid | Clear |
| Turbidity (NTU) | 483 | 542 | 659 | 1065 | 1405 | 0 |

The mixture was made up to 100% by weight with distilled water.

### Example 6

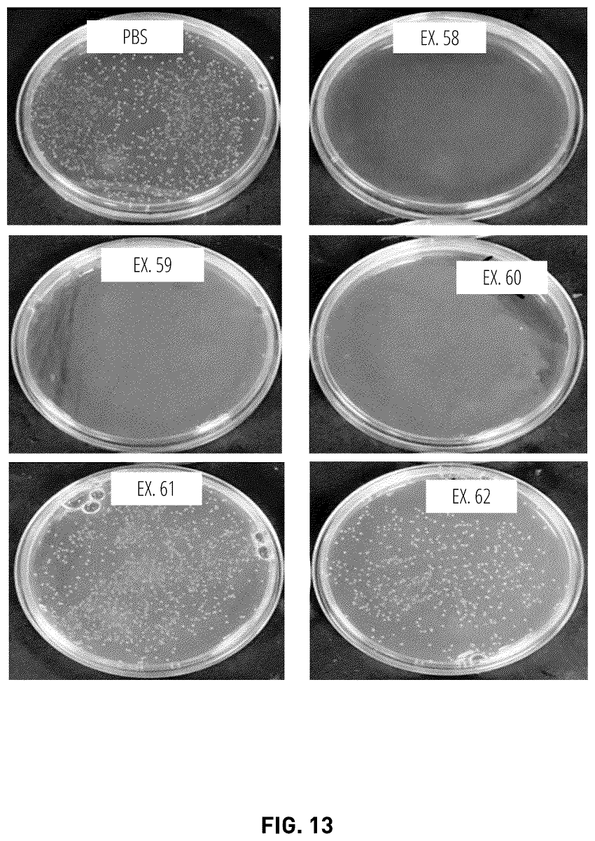

This experiment was conducted to determine antimicrobial activity of the compositions of the present disclosure described in Table 13 (Ex.58, Ex.59, Ex.60, Ex.61, and Ex.62) using the using ASTM International Method E2315. Ex.58 is a reference control and included 0.125% ADBAC and balanced to 100% with distilled water. Ex.59 was formulated in the same manner as Ex.58, but the pH was adjusted to 12.3 with KOH. Ex.60 was formulated in accordance with the teaching of the present disclosure, it is homogeneous, clear and stable. It has a total surfactants concentration of 0.42%, an alkaline pH of 12.3 and an anionic:cationic weight ratio >1 (2.4:1). The anionic surfactant in Ex.60 is K Laurate at 0.3% level of the composition, and the cationic surfactant is ADBAC at 0.125% level of the composition which is exactly the same level of ADBAC used in the reference control Ex.58. Ex.61 was formulated in the same manner as Ex.60, but it was lacking ADBAC and K Laurate. Ex.62 was formulated in the same manner as Ex.60, but it was lacking ADBAC. Ex.61 and Ex.62 which did not include the ADBAC were tested and found to be ineffective as disinfectants against Listeria monocytogenes. However, Ex.60 which comprised ADBAC at the same levels of 0.125% as the reference control Ex.58, proved to be as an effective disinfectant as the reference control with the same kill rate of 100% at 1 minute contact time as shown in Table 13 below and FIG. 13. Ex.59 shows that adjusting the pH to 12.3 did not affect the antibacterial activity of ADBAC.

FIG. 13 is a side-by-side photographic comparison between compositions Ex.58, Ex.59, Ex.60, Ex.61 and Ex.62. Ex.58 is an aqueous solution of pure ADBAC which served as a positive control and Phosphate Buffer Saline (PBS) served as a negative control. The anionic surfactant is K Laurate and the water-soluble cationic surfactant is ADBAC. Ex.58, Ex.59 and Ex.60 showed a complete kill (no growth of colony-forming units (CFUs)) of L. monocytogenes at 1 minute contact time. Ex.61 and the PBS showed no effect at all (overgrown: full of CFUs) and Ex.62 showed just a little effect (a growth of a few CFUs)

The data presented in this example provides a direct evidence that the inclusion of the anionic surfactant, as it is a neutralizer for QACs, which would be expected to decrease the antibacterial efficacy of the QACs; however, surprisingly and unexpectedly resulted, when used in accordance with the teaching of the present disclosure, in no decrease in activity as compared to the reference control Ex.58 that did not contain the anionic surfactant.

TABLE 13

| | Ex. 58 | Ex. 59 | Ex. 60 | Ex. 61 | Ex. 62 |
|---|---|---|---|---|---|
| Component | (wt. %) | (wt. %) | (wt. %) | (wt. %) | (wt. %) |
| K Laurate (4.75%, w/w) | 0 | 0 | 6.31 | 0 | 6.31 |
| ADBAC (4.75%, w/w) | 2.64 | 2.64 | 2.64 | 0 | 0 |
| KOH (4.5%, w/w) | 0 | 0.98 | 1.47 | 1.25 | 1.41 |
| Distilled Water | 97.36 | 96.38 | 89.58 | 98.75 | 92.28 |
| K Laurate:ADBAC wt. | — | — | 2.4:1 | — | — |
| ratio | | | | | |
| K Laurate:ADBAC mole | — | — | 3.52 | — | — |
| ratio | | | | | |
| Total surfactants conc. | 0.125 | — | 0.42 | — | — |
| (wt. %) | | | | | |
| pH | 6.55 | 12.3 | 12.3 | 12.3 | 12.3 |
| Appearance | Clear | Clear | Clear | Clear | Clear |
| Turbidity (NTU) | 0 | 0 | 0 | 0 | 0 |
| Reduction in L. | 100 | 100 | 100 | 0 | 8.5 |
| monocytogenes at 1 | | | | | |
| minute contact time (%) | | | | | |

The mixture was made up to 100% by weight with distilled water.

### Example 7

This example investigates the retention of ADBAC by cotton wipes. Compositions of the present disclosure were combined with cotton wipes to evaluate the effect of the cotton wipes exposures on the concentration of ADBAC in the cotton wipes eluates. The preparation of a wet cotton wipe according to the present disclosure comprised the preparation of the compositions and the loading of the compositions on the dry cotton wipes (substrate).

Compositions in accordance with the present disclosure shown in Table 14 were loaded onto unused cotton terry cloth white fabric made with 100% cotton. The anionic surfactant used in Ex.64 was SLS. Ex.63 served as a reference control and was made with 0.24% ADBAC and balanced to 100% with distilled water. The cotton terry cloth fabric was cut into pieces of approximately 15 cm×15 cm and impregnated by spraying them with the compositions at a rate sufficient to obtain a loading factor of at least about 2.5 grams of composition per gram of dry wipe. The average weight of the liquid, for each composition within each cotton wipe, did not vary by more than 0.1 g. After an appropriate contact time of 120 minutes between the compositions and the cotton wipes, the liquid from the cotton wipes was expressed into clean wide mouth storage bottles by gently wringing the cotton wipes for approximately 30 seconds. The impregnated cotton wipes were handled with sterile gloves. A side-by-side comparison of the percent (%) ADBAC retained in Ex.63 and Ex.64 by the cotton wipes indicates that the retention of Ex.64 is far less than the retention of the reference control Ex.63. In fact, Ex.64 which was formulated in accordance with the teaching of the present disclosure using SLS as the anionic surfactant and having 0.24% ADBAC, has 0% ADBAC retained by the cotton wipes. Whereas the amount of ADBAC retained in Ex.63 was 91.52%.

Thus, one can readily appreciate that the compositions of the present disclosure, which did not include the unreliable QACs release agents that yield inconsistent results, resulted in a dramatic reduction in the percentage of ADBAC retained by the cotton wipes.

TABLE 14

| | Ex. 63 | Ex. 64 |
|---|---|---|
| Component | (wt. %) | (wt. %) |
| SLS (4.75%, w/w) | 0 | 17 |
| ADBAC (4.75%, w/w) | 5 | 5 |
| KOH (4.5%, w/w) | 0 | 0 |
| Distilled Water | 95 | 78 |
| SLS:ADBAC weight ratio | — | 3.4:1 |
| SLS:ADBAC mole ratio | — | 4.14 |
| Total surfactants conc. | 0.24 | 1.04 |
| (wt. %) | | |
| pH | 6.81 | 10.41 |
| Appearance | Clear | Clear |
| Turbidity (NTU) | 0 | 0 |
| Exposure time to cotton | 120 | 120 |
| wipes (minutes) | | |
| Percent retention of ADBAC | 91.52 | 0 |
| by cotton wipes (%) | | |

The mixture was made up to 100% by weight with distilled water.

### Example 8

Cotton wet wipes according to Example 7 are prepared except that composition of Ex.64 was replaced with composition Ex.66 having its components set forth in Table 15. The anionic surfactant used in Ex.66 was K Laurate. Ex.65 served as a reference control and was made with 0.14% ADBAC and balanced to 100% with distilled water.

The average weight of the liquid, of the compositions within each cotton wipe, did not vary by more than 0.1 g. After an appropriate contact time of 120 minutes between the compositions and the cotton wipes, the liquid from the cotton wipes was expressed into clean wide mouth storage bottles by gently wringing the cotton wipes for approximately 30 seconds. The impregnated cotton wipes were handled with sterile gloves. A side-by-side comparison of the percent (%) ADBAC retained in Ex.65 and Ex.66 by the cotton wipes indicates that the retention of Ex.66 is far less than the retention of the reference control Ex.65. Ex.66 which was formulated in accordance with the teaching of the present disclosure using K Laurate as the anionic surfactant and having 0.14% ADBAC, has 0% ADBAC retained by the cotton wipes; whereas the amount of ADBAC retained in Ex.65 was 90.18%.

Thus, one can readily appreciate that the compositions of the present disclosure, which did not include the unreliable QACs release agents that yield inconsistent results, resulted in a dramatic reduction in the percentage of ADBAC retained by the cotton wipes.

TABLE 15

| | Ex. 65 | Ex. 66 |
|---|---|---|
| Component | (wt. %) | (wt. %) |
| K Laurate (4.75%, w/w) | 0 | 35 |
| ADBAC (4.75%, w/w) | 3 | 3 |
| KOH (45%, w/w) | 0 | 0.81 |
| Distilled Water | 97 | 61.19 |
| K Laurate:ADBAC weight | — | 11.7:1 |
| ratio | | |
| K Laurate:ADBAC mole ratio | — | 17.18 |
| Total surfactants conc. (wt. %) | 0.14 | 1.8 |
| pH | 6.57 | 13 |
| Appearance | Clear | Clear |
| Turbidity (NTU) | 0 | 0 |
| Exposure time to cotton | 120 | 120 |
| wipes (minutes) | | |
| Percent retention of ADBAC | 90.18 | 0 |
| by cotton wipes (%) | | |

The mixture was made up to 100% by weight with distilled water.

The mixture was made up to 100% by weight with distilled water.

### Example 9

Cotton wet wipes according to Example 8 were prepared having their components set forth in Ex.68 and Ex.69 as described in Table 16. Ex.68 and Ex.69 both have the same amount of ADBAC, 0.14%. Ex.69 was formulated according to the teaching of the present disclosure, whereas Ex. 68 was not. Ex.67 served as reference controls and was also made with 0.14% ADBAC and balanced to 100% with distilled water. Ex.67 was not exposed to the cotton wipes.

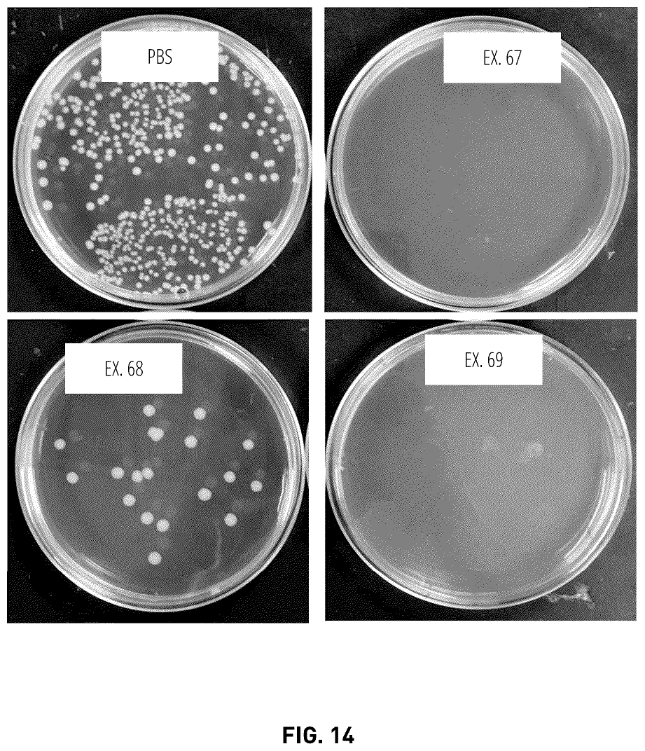

Antibacterial efficacy tests were performed on Ex.67 and the cotton wipe eluates of Ex.68 and Ex.69 using ASTM International Method E2315. Bacterial reduction would be present in any cotton wet wipe containing the composition of the present disclosure. The cotton wipe eluates of Ex.68 and Ex.69 showed 21.55% and 100% reduction in E. coli at 1 minute exposure time, respectively. The reference control Ex.67 that was not exposed to the cotton wipes showed 100% reduction of E. coli at the same exposure time of 1 minute used in Ex.68 and EX.69. A side-by-side comparison of the percent reduction of E. coli obtained by the reference control Ex.67 that was not exposed to the cotton wipes and the eluate of Ex.69 ascertains the similarity in antibacterial activities, which indicates the efficacy of the compositions of the present disclosure are not affected by the exposure to the cotton wipes and the inclusion of the anionic surfactant. However, Ex.68 that was not formulated according to the teaching of the present disclosure and exposed to the cotton wipes showed at the same contact time of 1 minute just 21.55% reduction in E. coli, which is significantly less than the reduction observed in Ex.67 and Ex.69 as shown in Table 16 and FIG. 14.

FIG. 14 is a side-by-side comparison between compositions Ex.67, Ex.68 and Ex.69. Ex.67 is an aqueous solution of pure ADBAC which served as a positive control and Phosphate Buffer Saline (PBS) served as a negative control. The anionic surfactant is K Laurate and the water-soluble cationic surfactant is ADBAC. Ex.67 and Ex.69 showed a complete kill (no growth of CFUs) of E. coli at 1 minute contact time. Ex.68 showed just a mild effect (a growth of a few CFUs) and the PBS had no effect at all (overgrown: full of CFUs).

The data presented in this example provides a direct evidence that the exposure of the compositions of the present disclosure containing QACs to the cotton wipe, as it is a binder for QACs, and the inclusion of the anionic surfactant, as it is a neutralizer for QACs, which both independently or conjointly would be expected to decrease the antibacterial efficacy of the QACs; however, surprisingly and unexpectedly resulted, when used in accordance with the teaching of the present disclosure, in no decrease in activity as compared to the reference control Ex.67 that did not contain the anionic surfactant and was not exposed to cotton wipes.

TABLE 16

| | Ex. 67 | Ex. 68 | Ex. 69 |
|---|---|---|---|
| Component | (wt. %) | (wt. %) | (wt. %) |
| K Laurate (4.75%, w/w) | 0 | 0 | 35 |
| ADBAC (4.75%, w/w) | 3 | 3 | 3 |
| KOH (45%, w/w) | 0 | 0 | 0.79 |
| Distilled Water | 97 | 97 | 61.21 |
| K Laurate:ADBAC weight | — | — | 11.7:1 |
| ratio | | | |
| K Laurate:ADBAC mole ratio | — | — | 17.18 |
| Total surfactants conc. | 0.14 | 0.14 | 1.8 |
| (wt. %) | | | |
| pH | 6.89 | 6.89 | 13 |
| Appearance | Clear | Clear | Clear |
| Turbidity (NTU) | 0 | 0 | 0 |
| Exposure time to cotton | 0 | 120 | 120 |
| wipes (minutes) | | | |
| Percent retention of ADBAC | *N/A | 90.18 | 0 |
| by cotton wipes (%) | | | |
| Reduction in E. coli at | 100 | 21.55 | 100 |
| 1 minute contact time (%) | | | |

The mixture was made up to 100% by weight with distilled water.
*N/A: Not Applicable

### Example 10

A cotton wet wipe according to Example 8 was prepared having its components set forth in Ex.71 as described in Table 17. Ex.70 and Ex.71 were formulated according to the teaching of the present disclosure and both have the same composition including the amount of ADBAC, 0.14%. Ex.70 was not exposed to the cotton wipes and served as a reference control.

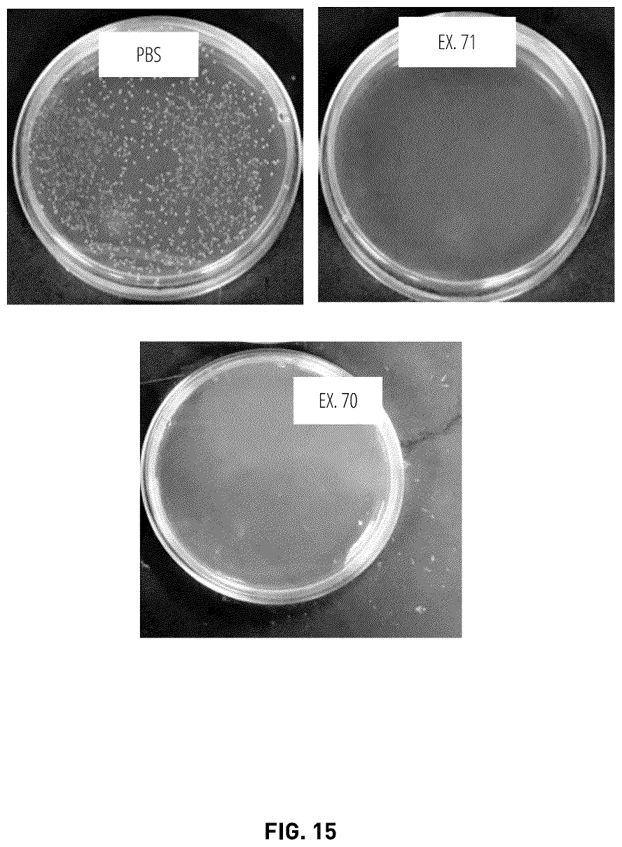

Antibacterial efficacy tests were performed on Ex.70 and the cotton wipe eluate of Ex.71 using ASTM International Method E2315. The reference control Ex.70 that was not exposed to the cotton wipes showed 100% reduction of Listeria monocytogenes at 1 minute exposure time. The cotton wipe eluate of Ex.71 also showed 100% reduction in Listeria monocytogenes at the same exposure time of 1 minute. A side-by-side comparison of the percent reduction of Listeria monocytogenes obtained by the reference control Ex.70 that was not exposed to the cotton wipes and the eluate of Ex.71 ascertains the similarity in antibacterial activities, which indicates the efficacy of the compositions of the present disclosure are not affected by the exposure to the cotton wipes as shown in Table 17 and FIG. 15.

FIG. 15 is a side-by-side comparison between compositions Ex.70 and Ex.71. They both have the same composition including the amount of ADBAC, 0.14%. Ex.70 was not exposed to the cotton wipes and served as a reference control and Phosphate Buffer Saline (PBS) served as a negative control. The anionic surfactant is K Laurate and the water-soluble cationic surfactant is ADBAC. Ex.70 and Ex.71 showed a complete kill (no growth of CFUs) of L. monocytogenes at 1 minute contact time and the PBS had no effect at all (overgrown: full of CFUs).

The data presented in this example also provides a direct evidence that the exposure of the compositions of the present disclosure containing QACs to the cotton wipe, as it is a binder for QACs, which would be expected to decrease the antibacterial efficacy of the QACs; however, surprisingly and unexpectedly resulted in no decrease in activity as compared to the reference control Ex.70 that was not exposed to cotton wipes.

TABLE 17

| | Ex. 70 | Ex. 71 |
|---|---|---|
| Component | (wt. %) | (wt. %) |
| K Laurate (4.75%, w/w) | 35 | 35 |
| ADBAC (4.75%, w/w) | 3 | 3 |
| KOH (45%, w/w) | 0.79 | 0.79 |
| Distilled Water | 61.21 | 61.21 |
| K Laurate:ADBAC weight ratio | 11.7:1 | 11.7:1 |
| K Laurate:ADBAC mole ratio | 17.18 | 17.18 |
| Total surfactants conc. (wt. %) | 1.8 | 1.8 |
| pH | 13 | 13 |
| Appearance | Clear | Clear |
| Turbidity (NTU) | 0 | 0 |
| Exposure time to cotton | 0 | 120 |
| wipes (minutes) | | |
| Percent retention of ADBAC | *N/A | 0 |
| by cotton wipes (%) | | |
| Reduction in L. monocytogenes | 100 | 100 |
| at 1 minute contact time (%) | | |

The mixture was made up to 100% by weight with distilled water.
*N/A: Not Applicable

### Example 11

This experiment shows the effect of evaporation enhancers (e.g., acetone) on the drying time of the compositions of the present disclosure. Wet wipes according to Example 7 were prepared except that various levels of acetone ranging from 0 to 60% were added to the compositions as set forth in Table 18 (Ex.72, Ex.73, Ex.74, Ex.75 and Ex.76). Ex.72 was formulated according to the present disclosure; therefore, it was homogeneous, clear and stable and served as a control for the drying time. Ex.72 has no acetone, a total surfactants concentration of 1%, an alkaline pH of 11.9 and an anionic:cationic weight ratio >1. Ex.73, Ex.74, Ex.75 and Ex.76 have the same composition as Ex.72 but with a portion of the deionized water being replaced with acetone. The apparent pH or operational pH of Ex.73, Ex.74, Ex.75 and Ex.76 due to the addition of the organic evaporation enhancer acetone was 12.2, 12.6, 13.4 and 14.1, respectively.

TABLE 18

| | Ex. 72 | Ex. 73 | Ex. 74 | Ex. 75 | Ex. 76 |
|---|---|---|---|---|---|
| Component | (wt. %) | (wt. %) | (wt. %) | (wt. %) | (wt. %) |
| K Laurate (11%, w/w) | 8 | 8 | 8 | 8 | 8 |
| ADBAC (4%, w/w) | 5 | 5 | 5 | 5 | 5 |
| KOH (4.5%, w/w) | 0 | 0 | 0 | 0 | 0 |
| Deionized Water | 87 | 77 | 67 | 47 | 27 |
| Acetone (100%, w/w) | 0 | 10 | 20 | 40 | 60 |
| K Laurate:ADBAC | 4:1 | 4:1 | 4:1 | 4:1 | 4:1 |
| weight ratio | | | | | |
| K Laurate:ADBAC mole | 6.48 | 6.48 | 6.48 | 6.48 | 6.48 |
| ratio | | | | | |
| Total surfactants conc. | 1 | 1 | 1 | 1 | 1 |
| (wt. %) | | | | | |
| pH | 11.9 | 12.2 | 12.6 | 13.4 | 14.1 |
| Appearance | Clear | Clear | Clear | Clear | Clear |
| Turbidity (NTU) | 0 | 0 | 0 | 0 | 0 |
| Drying time (seconds) | 240 | 165 | 120 | 90 | 50 |

The mixture was made up to 100% by weight with deionized water.

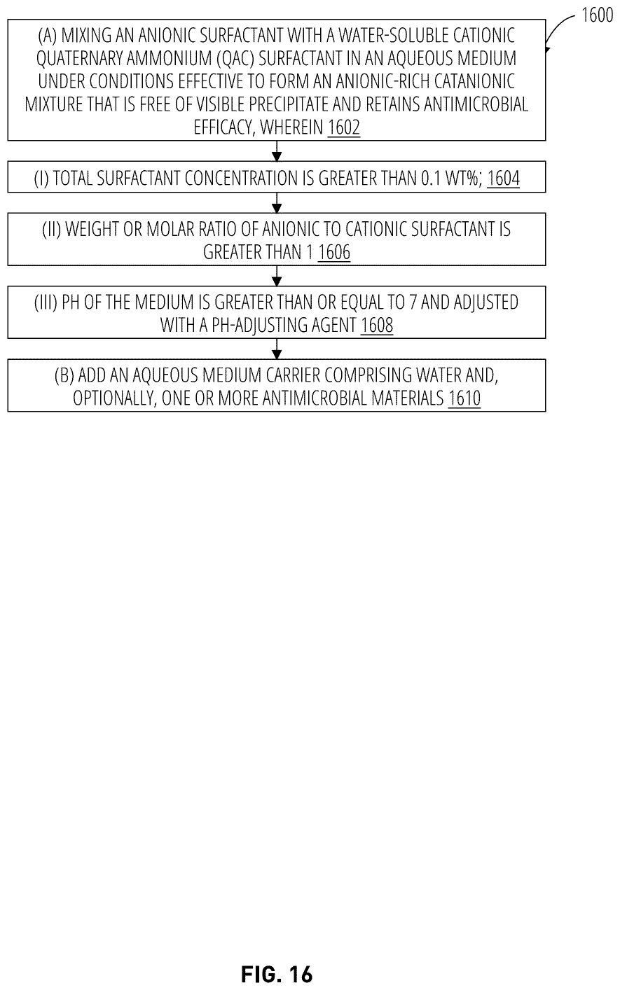

According to FIG. 16, an example method of making an antimicrobial composition 1600 according to the present disclosure is provided. In block 1602, routine 1600 (a) mixing an anionic surfactant with a water-soluble cationic quaternary ammonium (QAC) surfactant in an aqueous medium under conditions effective to form an anionic-rich catanionic mixture that is free of visible precipitate and retains antimicrobial efficacy, wherein. In block 1604, routine 1600 (i) total surfactant concentration is greater than 0.1 wt. In block 1606, routine 1600 (ii) weight or molar ratio of anionic to cationic surfactant is greater than 1. In block 1608, routine 1600 (iii) pH of the medium is greater than or equal to 7 and adjusted with a pH-adjusting agent. In block 1610, routine 1600 (b) adds an aqueous medium carrier comprising water and, optionally, one or more antimicrobial materials.

The embodiments of the disclosure described herein are exemplary and numerous modifications, variations and rearrangements can be readily envisioned to achieve substantially equivalent results, all of which are intended to be embraced within the spirit and scope of the disclosure. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application. It should be noted that the steps described in any method of use can be carried out in many different orders according to user preference. The use of “step of” should not be interpreted as “step for”, in the claims herein and is not intended to invoke the provisions of 35 U.S.C. § 112(f). Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

What is claimed is:

1. A method of making a clear, homogeneous aqueous antimicrobial composition, the method comprising:
(a) mixing an anionic surfactant with a water-soluble cationic quaternary ammonium (QAC) surfactant in an aqueous medium under conditions effective to form an anionic-rich catanionic mixture that is clear and free of visible precipitate and retains antimicrobial efficacy, wherein:
(i) total surfactant concentration is greater than 0.1 wt. %;
(ii) weight or molar ratio of anionic to cationic surfactant is greater than 1; and
(iii) pH of the medium is greater than or equal to 7 and adjusted with a pH-adjusting agent; and
(b) adding an aqueous medium carrier comprising water and, optionally, one or more antimicrobial materials.

2. The method of claim 1, wherein the antimicrobial material is added to the homogeneous aqueous antimicrobial composition and is selected from the group consisting of metal ion containing compounds, aromatic alcohols, lower alkanols, peroxides, essential oils, salts, organic acid salts, phenols, antibiotics, water-soluble bisbiguanides, and combinations thereof.

3. The method of claim 1, wherein the pH-adjusting agent is selected from potassium hydroxide, sodium hydroxide, calcium hydroxide, phosphate, carbonate, bicarbonate, laurates, and combinations thereof.

4. The method of claim 1, wherein the total surfactant concentration is from about 0.1 wt. % to about 20 wt. % and the anionic to cationic weight or molar ratio is in a range from about 1 to 30.

5. The method of claim 1, wherein the cationic surfactant comprises an alkyl-QAC and the alkyl group includes 8 to 18 carbon atoms.

6. The method of claim 5, wherein the alkyl-QAC is selected from alkyl dimethyl benzyl ammonium chloride, alkyl dimethyl ethyl benzyl ammonium chloride, didecyl dimethyl ammonium chloride, dialkyl dimethyl ammonium chloride, benzethonium chloride, cetylpyridinium chloride, and mixtures thereof.

7. The method of claim 1, wherein the cationic surfactant is selected from the group consisting of a polymeric QAC, an organosilane QAC, and a mixture thereof.

8. The method of claim 1, wherein the cationic surfactant comprises a polymeric QAC comprising one or more polyquaterniums.

9. The method of claim 1, wherein the cationic surfactant comprises an ethoxylated quaternary ammonium compound of the formula methyl poly(oxyethylene)C8-C18 alkyl ammonium chloride, wherein the poly(oxyethylene) includes 2-15 oxyethylene units.

10. The method of claim 1, wherein the cationic surfactant comprises a mixture of any two or more of the following:
(i) a QAC having at least one alkyl chloride, wherein the alkyl group includes from 8 to 18 carbon atoms, and the alkyl chloride is selected from the group consisting of alkyl dimethyl benzyl ammonium chloride, alkyl dimethyl ethyl benzyl ammonium chlorides, and combinations thereof;
(ii) at least one polymeric QAC having one or more polyquaterniums;
(iii) at least one ethoxylated QAC of the formula methyl poly(oxyethylene)C8-C18 alkyl ammonium chloride, wherein the poly(oxyethylene) includes an oxyethylene content from 2 to 15; and
(iv) at least one organosilane QAC selected from the group consisting of 3-(trimethoxysilyl) propyl dimethyl octadecyl ammonium chloride and 3-(trihydroxysilyl) propyl dimethyl octadecyl ammonium chloride.

11. The method of claim 1, wherein the anionic surfactant is selected from sulfonates, sulfates, fatty acid salts having 4-22 carbon atoms, and combinations thereof.

12. The method of claim 1, further comprising the step of adding a member selected from the group consisting of a saponified natural fat, coconut oil, corn oil, cottonseed oil, lard, olive oil, palm oil, palm kernel oil, peanut oil, rapeseed oil, safflower oil, sesame oil, soybean oil, sunflower oil, tallow, and mixtures thereof.

13. The method of claim 1, further comprising the step of adding essential oil or essential oil derivatives selected from the group consisting of thyme oil, eucalyptus oil, cinnamon oil, orange oil, lemon oil, clove oil, lime oil, rosemary oil, citronella oil, cedar wood oil, camphor oil, calamus oil, geranium oil, lavender, lemongrass oil, peppermint oil, vetiver oil, palmarosa oil, nutmeg oil, and combinations thereof.

14. The method of claim 1, further comprising the step of adding a nonionic surfactant.

15. The method of claim 14, wherein the nonionic surfactant is selected from alcohol ethoxylates, alcohol propoxylates, alkyl polyglucosides, amine oxides, and mixtures thereof.

16. The method of claim 1, further comprising the step of adding 1-80 wt. % of an evaporation enhancer selected from silicone-based materials, ketones, lower alkanols, and mixtures thereof.

17. The method of claim 16, wherein the lower alkanols are ethanol, n-propanol, isopropanol, or mixtures thereof.

18. The method of claim 1, further comprising the step of adding an organic acid selected from lactic acid, citric acid, salicylic acid, benzoic acid, 2-furan carboxylic acid, or mixtures thereof.

19. A method for maintaining antimicrobial activity of a quaternary ammonium compound (QAC) by reducing its binding to a cellulosic substrate, the method comprising:
(a) forming an anionic-rich catanionic mixture that is clear and free of visible precipitate and that retains antimicrobial efficacy by mixing at least one anionic surfactant with water-soluble cationic QACs in an aqueous carrier to form a composition, wherein the total surfactant concentration is greater than 0.1 wt. %; the weight or molar ratio of the anionic surfactant to the QAC is greater than 1 and the pH of the composition is greater than or equal to 7; and
(b) applying the composition to the cellulosic substrate, whereby the binding of the QAC to the cellulosic substrate is reduced as compared to a composition lacking the at least one anionic surfactant.

20. The method of claim 19, wherein the cellulosic substrate is a cotton wipe or a synthetic wipe and the at least one anionic surfactant is selected from the group consisting of sodium lauryl sulfate and potassium laurate.
